(19) United States
(12) Patent Application Publication
(10) Pub. No.: US 2025/0390511 A1
(43) Pub. Date: Dec. 25, 2025

(54) Method and System for Tagging of Data Within Datastores

(71) Applicant: Vigilant AI Inc, Ottawa (CA)

(72) Inventors: Mark Hedley, Dorset (CA); Daniel Willis, Smith Falls (CA); John Craig, Ottawa (CA); Peter Fong, Stittsville (CA); Helge Brueggemann, Vernon (CA); Ronnie Jensen, Kamloops (CA)

(21) Appl. No.: 18/808,053

(22) Filed: Aug. 18, 2024

Related U.S. Application Data
(60) Provisional application No. 63/520,612, filed on Aug. 19, 2023.

(51) Int. Cl. G06F 16/28

(52) U.S. Cl. CPC G06F 16/285

(57) ABSTRACT

A method is disclosed for ingesting and tagging data relating to data elements within a datastore based on features other than merely a word or contiguous words. The data elements are identified within the datastore according to a location of the identified data element, the associated tag, and an aspect of the tagged data element is stored within another datastore. At least one of the location, associated tag, and the aspect of the data is indexed.

### FIELD OF THE INVENTION

The invention relates generally to data organisation and more specifically to a method of tagging and indexing stored data.

### BACKGROUND

In document management, abstracts are generated by authors to make searching and retrieving of documents easier. The abstract allows an author to highlight the most important aspects of a paper for easy access and quick review by other researchers. The abstract, when well-written, provides an overview of the document contents and purpose. It makes filtering of returned documents easier while reducing the amount of information that must be evaluated.

In file management, metadata within each file is relied upon for searching. This makes sense because early computer systems were not likely to comprehend document contents. Thus, metadata typically included the file name, the last time a file was accessed and when the file was created.

A third approach to data management involves brute force searching for text within documents. When documents were all stored as text, it was a long process to read each word in each file and to search for “search terms.” This process was limited both because of the processing time required and because of the difficulty in using brute force to perform complex searches.

With the advent of personal computers and modern operating systems, a process exists wherein file data is indexed based on text contents of the files allowing for faster information search and retrieval than a brute force approach. Unfortunately, these methods are significantly limited just like the brute force approach, though they execute more quickly. Today, computer-based indexing systems also are capable of translating files from common formats into text for indexing purposes allowing for indexing of text information stored in a variety of formats.

It would be advantageous to improve the usefulness, performance, and effectiveness of at least some data retrieval processes.

### SUMMARY OF EMBODIMENTS

In accordance with embodiments of the invention there is provided a method comprising: ingesting data from within a datastore comprising: sequentially accessing data within the datastore; correlating the accessed data with a correlation process to detect data segments for being associated with predetermined tags; associating data elements when detected with a first predetermined tag; and storing a record associated with the tag and the data element and a location of the data element within the datastore.

In another embodiment, there is provided a method comprising: scanning an email file to determine words and phrases that relate to a tag within a predetermined set of tags; associating related tags with email contents to form a record comprising an identifier of the email, a location within the email, a tag and a hash to support verification of the email message; and storing the record within a datastore.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified diagram of a computer network according to the prior art.

FIG. 2 and FIG. 2B are simplified diagrams of a file system metadata approach according to the prior art.

FIG. 3 is a simplified diagram of a file header metadata approach according to the prior art.

FIGS. 4A, 4B, 4C, and 4D (collectively FIG. 4) is a simplified flow diagram of a method of tagging and indexing, showing the ingestion of analytical data tables for the construction of tagging and indexing in supradata.

FIGS. 5A and 5B (collectively FIG. 5) is a simplified diagram illustrating planes of tagging by index or by set.

FIGS. 6A and 6B (collectively FIG. 6) is a simplified illustration of a multi-classification tag hierarchy or structure.

FIG. 7A and FIG. 7B (also referred to as FIG. 7) is a simplified method for data retrieval in a multi-classification, structured tag hierarchy architecture.

FIG. 8 is a simplified method for data extraction in a multi-faceted, multi-classification scenario made easier with structured tagging to unify the data and reduce or eliminate organizational silos.

FIGS. 9A and 9B (collectively FIG. 9) is simplified illustration of a tag structure cross-correlated with and providing context across a multiplicity of data sources, media, and data sets. It shows a tag flow establishing context and a reference point for other flows.

FIG. 10 is a simplified method of data ingestion with its context, its supra-data, de-coupled from the actual data element or file.

FIG. 11 is a simplified method of data ingestion where the original data is modified or deleted but the context remains.

FIG. 12 is a simplified method, showing data element ingestion with digital signatures and data integrity mechanisms where the data element is embedded as a file within a data archive or imbedded within a file.

FIG. 13 is an illustration of supra-data tagging of various facets of data elements.

FIG. 14 is a simplified method for the continuous tagging and indexing of ingested data augmenting the data set and enhancing its context in an on-going basis.

FIG. 15 is a simplified method for the tagging and indexing of a specified subset of a much larger data set to achieve a more refined and focused solution set.

FIG. 16 is an illustration of a simplified method for temporary tagging.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Metadata: Metadata is data stored associated with a file or with a data element but not forming part of the data element content. Common forms of metadata include filename, file type, date of creation and date of last modification. Within a data file system, metadata is stored for each file, often within a table of entries comprising file names, and locations. Some metadata is stored within a file, for example in the file header or in its own portion. Other metadata is stored within a file system in association with a file. Typically, metadata is not displayed when displaying file content as intended; metadata is sometimes displayed in association with file system content.

Supradata: supradata is a combination of metadata, context, associations, actions, and relationship elements that are stored in a time varying fashion such that supradata is appended to previous supradata instead of overwriting same to form a present, historical, and continuously deepening understanding of the data set. In addition, supradata includes context regarding the data element. The context may give reference to the origins of the data, the purpose of the data, or the contents of the data. Context also includes actions on, interactions with, and relationships with other data elements within a data set and across data sets. By example, a PDF contract file may include a link to the email to which it was attached, which in turn contains a link to the email archive from which the email was extracted all within the current or some other external data set.

File update data: file update data comprises data relating to changes to a file content.

File access data: file access data comprises data relating to a file access within a file storage system.

File title data: file title data comprises data relating to one or more file identifiers such as file name, file number, and file identifier.

File version data: file version data comprises data relating to a file with ongoing changes made to the file and to which version of the changing file in order to distinguish one version from another; often file version data comprises a version number.

Data elements: are meaningful segments of information logically identifiable but not necessarily constrained by a one-to-one relationship to a traditional file. For example, an email archive file is a single file which may contain many data elements in the form of emails which in turn may contain additional data elements such as topics, senders, receivers, transmission headers, a message body, and attachments.

Tag: is a data element in supradata which acts as a common relationship reference point that is used to associate like data elements in one or more supradata data sets. All supradata data elements which are associated with a given tag are said to be tagged with it.

Index entry: is one of a multiplicity of entries in an index, where each entry references a data element and has direct associative relationship links to all occurrences of that data element in the indexed source data set(s).

Index: collective set of index entries as associated with one or more supradata data sets.

Immutable: is a characteristic of published data sets. Immutable in this context has the connotation of being fixed and unchanging. Immutable data sets enable consistent, repeatable, deterministic behaviors.

Hash: a cryptographic, mathematical calculation which tries to uniquely identify a specific data element or file. An effective hash ensures no two non-identical data elements/files of the same size will calculate via the same algorithm to the same hash value. Matching collisions where the hash values do align will be exceedingly rare. In some implementations, less effective hashes, those having more matching collisions remain sufficient.

Signature: a property of a data element which uniquely identifies that data element and validates its data integrity, often through use of Digital Hashing.

Digital Signature: a form of signature property associated with a data element which is based on a signature depending on the hash value of the data element itself and is used to uniquely, unambiguously, and cryptographically ensure the data integrity of the data element with which it is associated.

Archive or Data Archive has two definitions in context:
a. (noun) A collection of data elements or files combined into a single file.
b. (verb) To either create or add to an existing Data Archive.

Storage Archive: a means of long-term storage whereby data is persisted and maintained, typically at a lower cost and often with an associated time lag in recovering data from within the storage archive.

Archived: as a verb is the past tense of Archive and as an adjective indicates that one or more data elements have been included in a storage archive.

Tag Associated Process: process whereby a data element is relationship-associated with a tag. All data elements associated with the tag share the commonality of an exact or near (fuzzy) match to the tag.

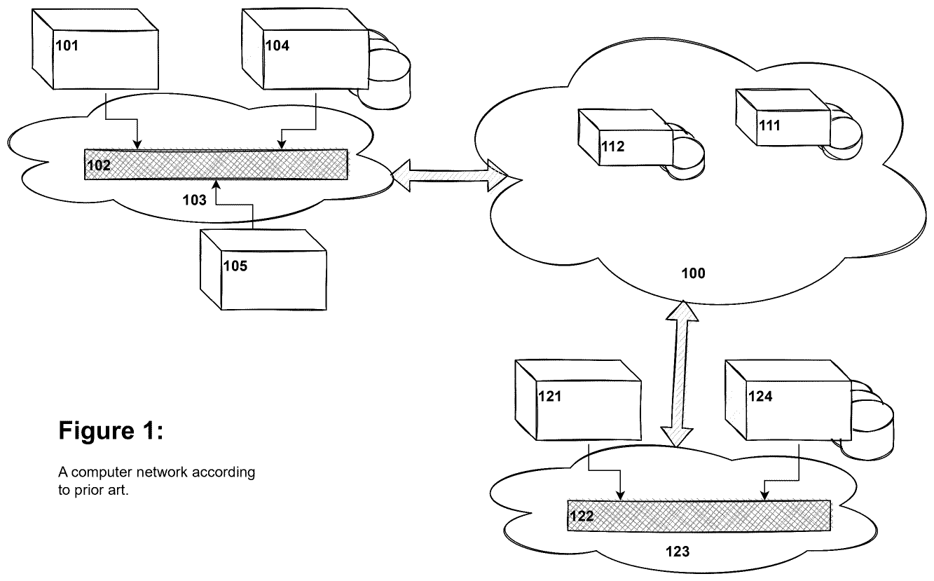

Referring to FIG. 1, shown is a computer network according to the prior art. A first computer 101 is communicatively coupled to a router 102 for forming a local area network 103. The local area network includes server 104 and second computer 105. Local area network 103 is communicatively coupled to Internet 100. Also communicatively coupled to Internet 100 is cloud server 111, server 112, LAN 123 including router 122, computer 121 and server 124. In use computer 101 communicates with server 104 via the local area network 103 and with cloud server 111 via the local area network 103 and the Internet 100.

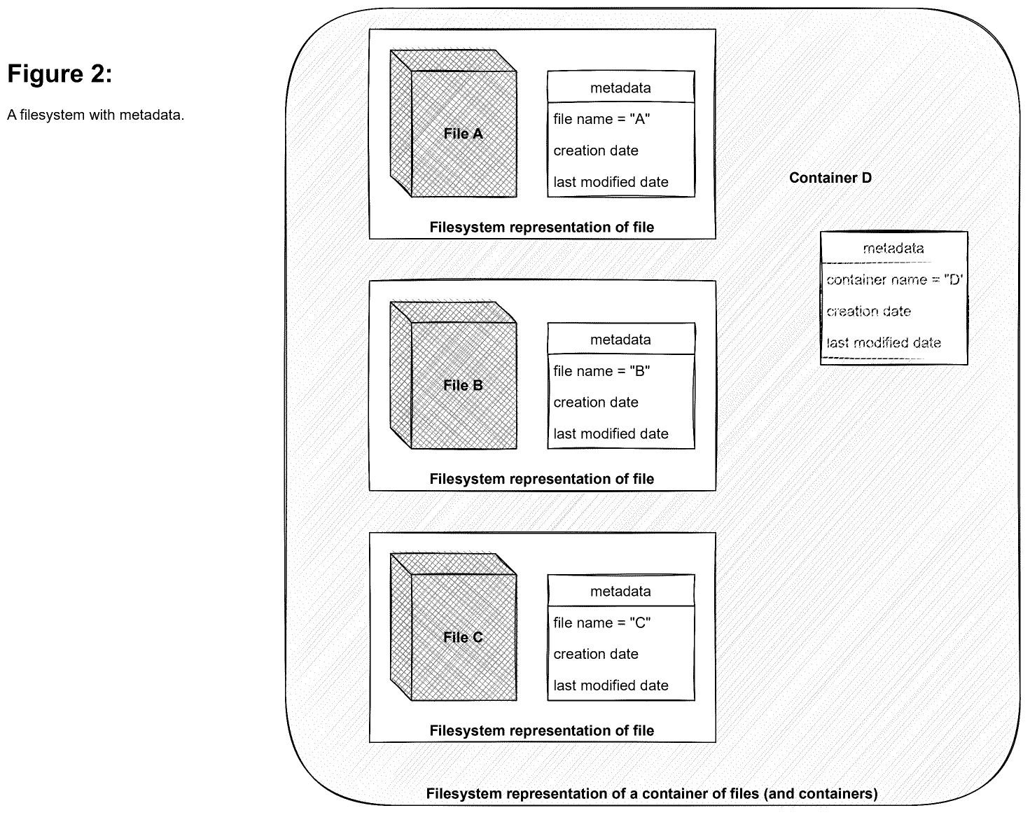

Referring to FIGS. 2 and 2B, shown is a file system metadata approach according to the prior art. Here, for each file a list of information values is stored including file name, file creation date, file last modified date, etc. As illustrated in FIG. 2B 2.5, each time a given file or container is modified, the modified date is updated to reflect the last time the file was modified. Each time the file name is changed, the previous value is overwritten. Thus, at any time the metadata shows a set of values reflective of the originating information and recent changes of the file.

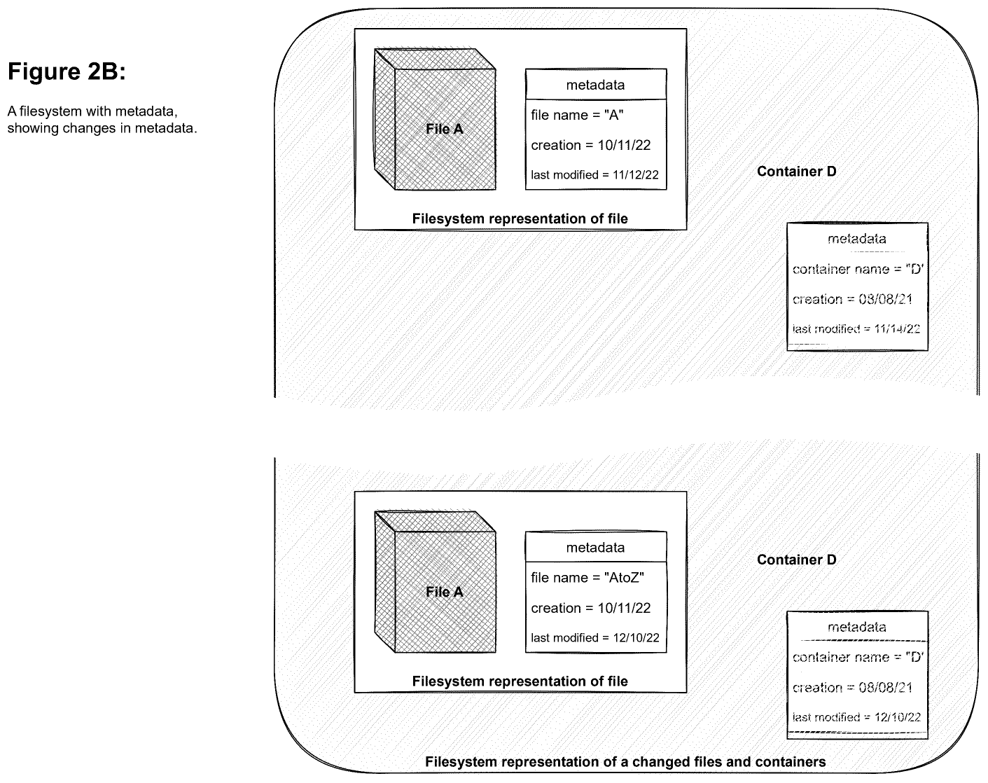

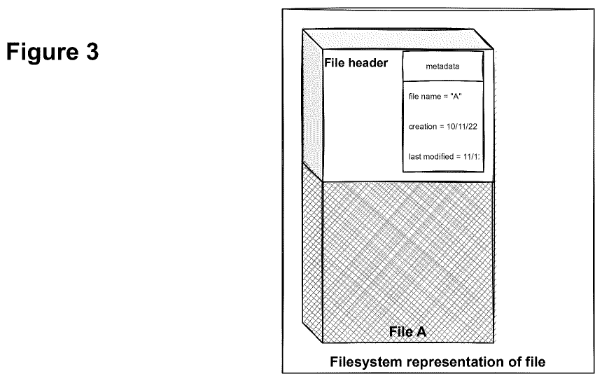

Referring to FIG. 3, shown is a file header metadata approach according to the prior art. Here, a programmer or a user enters information at the header of a file to make searching and accessing the file more convenient. A photograph might have metadata added thereto by the photographer indicating who is in the photograph and where it is taken. Alternatively, the GPS coordinates where it is taken are automatically stored in the photographs metadata. Typically, other file metadata such as ‘date created’ and ‘file name’ are also associated with each photograph. Optional in-situ metadata of this form may articulate the camera settings when the photograph was taken, e.g., f-stop, shutter speed, lens length, and exposure/film criteria.

By creating metadata in this fashion, photo data sets are more easily searched and retrieved. If each picture with a mother and child is tagged with the phrase “mother and child,” then searching mother and child returns all those photographs. Otherwise, searching mother and child will not return any photographs as the phrase is not within the images—an image of a mother and child is. Thus, human created metadata is very useful for organisation and retrieval of non-textual information. It is also useful for retrieval of text information where similar headings or groupings exist. For example, “Fingerprint” is used in crime stories, computer security, criminal investigation and in DNA analysis. Thus, if you were relating information relating to computer security and about fingerprint analysis, including computer security and biometrics in the metadata would be helpful if those words or phrases are not in the document itself.

Unfortunately, the same thing that makes human entered metadata so powerful also makes its abuse simple and common place. A web site for a particular product might use metadata relating to competing products. A website seeking to draw traffic might use metadata to fool search engines into listing them when they lack relevance. Human entered metadata is easily manipulated and has given rise to an entire industry, Search Engine Optimization.

Therefore, the prior art regarding metadata is somewhat limited in scope. It would be highly advantageous to improve computing and data analytics efficiency by developing a directly addressable, richer and deeper contextual understanding of the data element(s) in question, which is not susceptible to the time cost and inaccuracies of manually entered supplemental information.

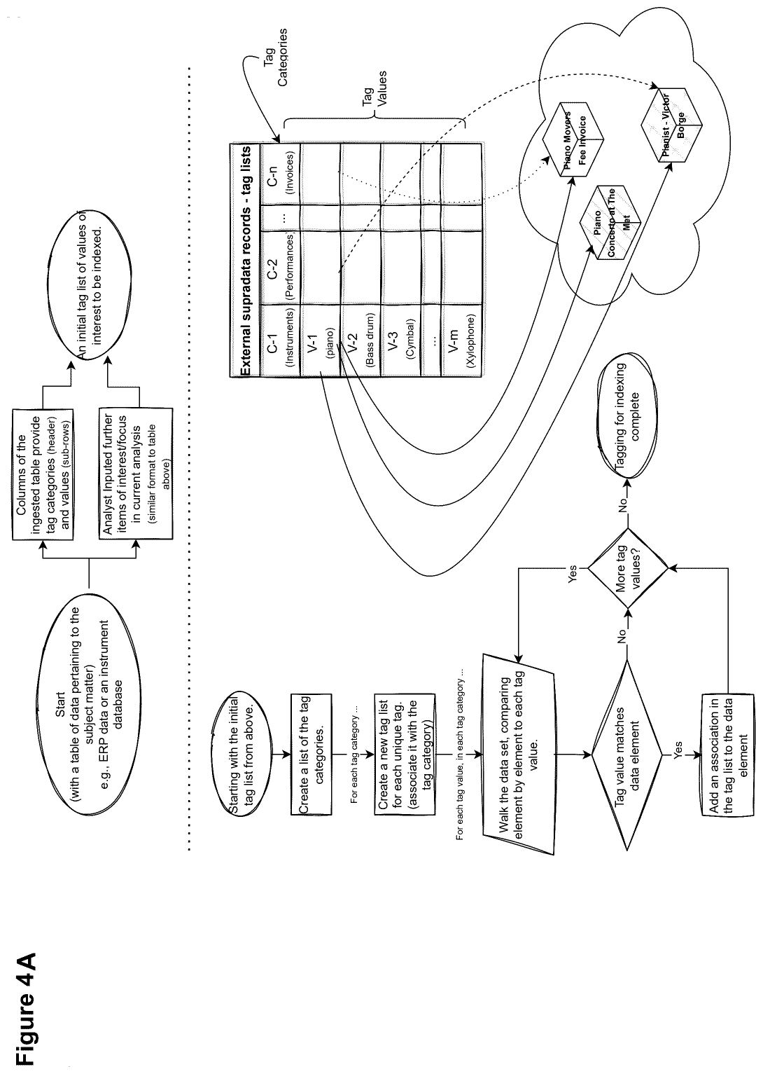

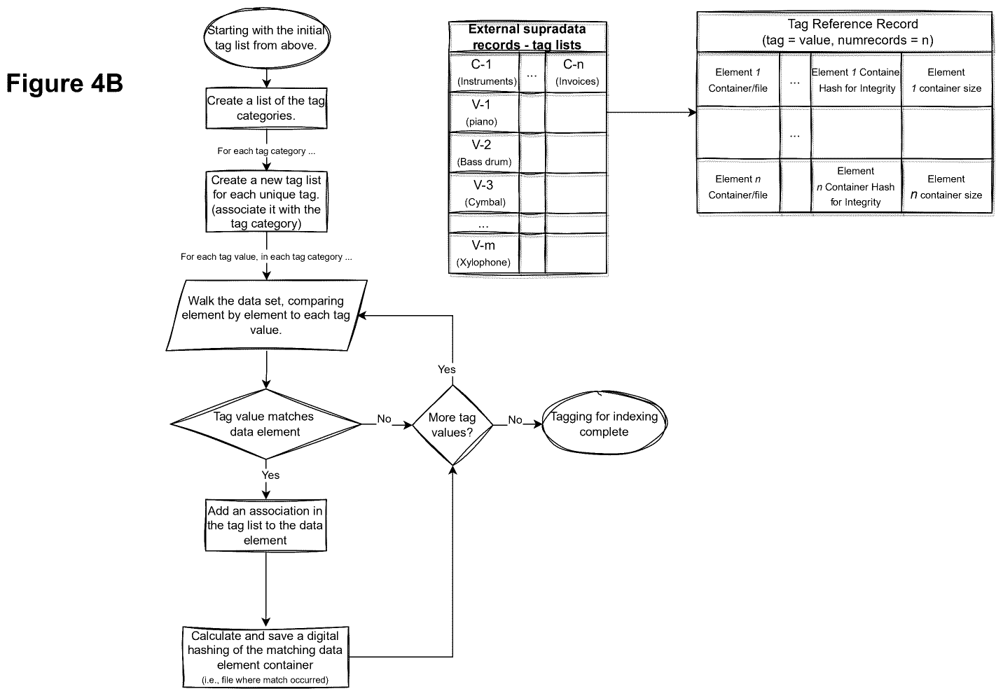

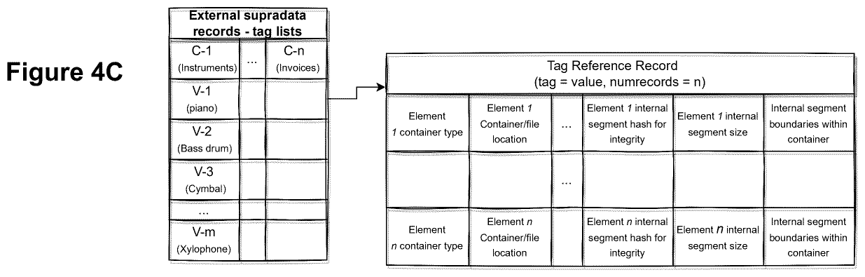

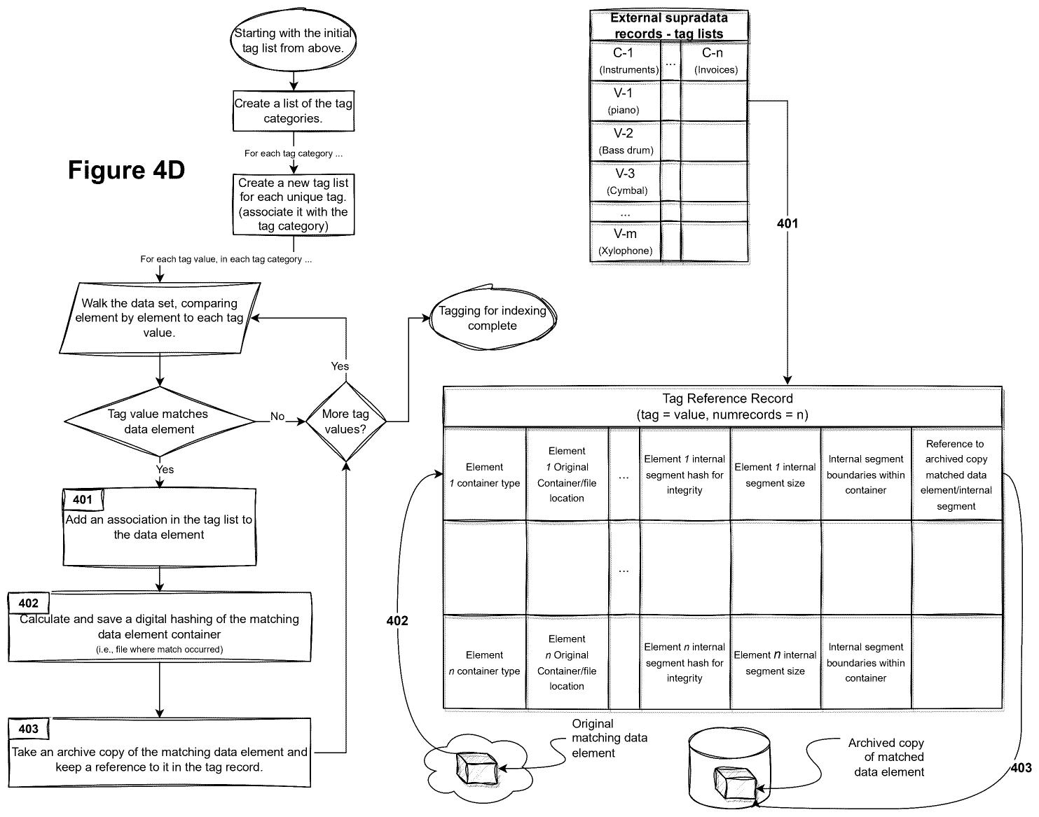

Referring to FIGS. 4A, 4B, 4C, and 4D, shown are different methods of tagging data within a datastore. Referring to FIG. 4A, it would be advantageous if the initial list of tags to be created and discovered throughout the target data set are targeted. For example, such targeting begins with the list of tags to be generated. They can be automatically sourced from a table or data set that is already associated with or focused on an analyst's area(s) of interest. For example, it could be an ERP (enterprise resource planning) or financial data table or a subject matter data table, such as music, performances, or instruments. By starting the tag list from a table of known data-of-interest the indexing which occurs will have a higher relevance to the analysis.

Still referring to FIG. 4A, from the initial tag list for each unique tag identifier, a tag list is created each tag entry identifying matching files and location(s) within the file. As used here the term file refers to an identifiable and retrievable piece of data, a data element, or a data segment. For example a file, a record, a sector, an embedded object, an object, etc. are all entities which could be tagged. Thus, a tag identifier such as “invoice” is then associated with a list of invoice related data segments within data objects. Unlike a prior art indexing, the tag for “invoice” encompasses more than the simple text “invoice.” For example, it includes indirect associations such as charges, bills, approvals, etc. Alternatively, the tag invoice merely points to the text “invoice.”

In another example relating to FIG. 4A, the tag identifier “Piano” is associated with a list of segments or elements including the text “piano,” images of piano, piano music, music including piano, piano concertos, animation of pianos falling on characters, news about pianos, etc. Such a tag is associated with a family of data elements of different types across data lakes and media sources, text, audio, video, sheet music, animation, news, etc.

The results of the process shown in FIG. 4A is a list of tag related segments and a location for retrieving same. The list is stored separate from the segments and therefor is not destroyed if the data is destroyed or modified. Storing the list separately also allows tag related data to cover multiple storage types, devices, and locations.

Referring to FIG. 4B, another process for storing data relating to a tag is shown wherein for each data element a location of its container, which may be a file, is stored along with a hash value and size of the container, calculated and added to the record, for verifying that the data within the container is unaltered since last being tagged.

Referring to FIG. 4C, following the same methodology as outlined with reference to FIGS. 4A and 4B, shown is another example for storing data relating to a tag association. In this example, the location of the container is maintained, as is the location of a segment containing the embedded data element within its container maintained. Integrity hashes are maintained for the container and/or the internal segment containing the embedded data. An example of such a construct is a reference to embedded data which resides within a file, where the file resides in a data archive. Another example at a finer granularity is where a larger container exists such as a large file and the matching data element resides within a segment of interest in the file. Without limitation, one such example could be a match against part of a specific video clip within a larger video file. In the example the video file is the container, the segment of interest is the video clip, with a known start and end time, and the matching data element might be the audio track for that clip.

Referring to FIG. 4D, another process for storing data relating to a tag is shown wherein the process archives at least one of all relevant data and all data such that for each data element a segment location within the original data and within the archive is stored for verifying that the data within the segment is unaltered and for retrieving the data when necessary. As illustrated in step 401, when a tag value matches a data element, a new record is added to the tag list specific to that tag. The first field in that tag list record is a reference, an association with the tag, to the location of the data element. In an embodiment, the reference includes an indicator of the type of the container of the data element in the form of a format. For example, a type a file type such as a PDF (portable document format) file and a video file. The next addition to the tag reference in the associated tag list are two fields intended to help maintain data integrity of the container of the data element, thereby maintaining integrity of the data element itself.

In step 402, a digital hash is taken and stored in the tag list data record of the container, for example one of a file, an archive and a video clip that holds the matched data element. Also, a size of the container is captured and persisted in the associated tag data record.

In step 403, shown is optional copying of the matching data element and archiving thereof for security and persistence. Where data preservation and recovery are critical and should the original no longer be available, the archived copy can be reconstituted for full data recovery. In this manner, the reference is noted and an immutable copy is preserved for future reference. Alternatively, the hash is usable to prevent changing of the underlying data without such a change being detectable; however, many forms of hash do not provide for data reconstruction.

Thus, depending on functional requirements, different levels of indexing associative data are stored to allow for data analysis and retrieval.

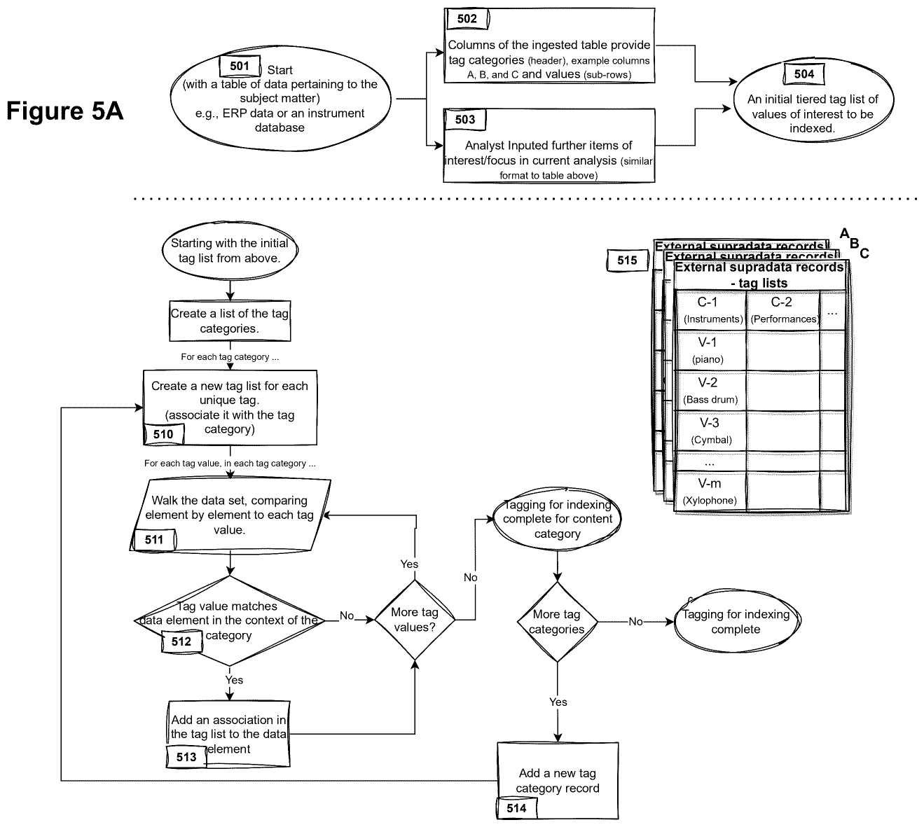

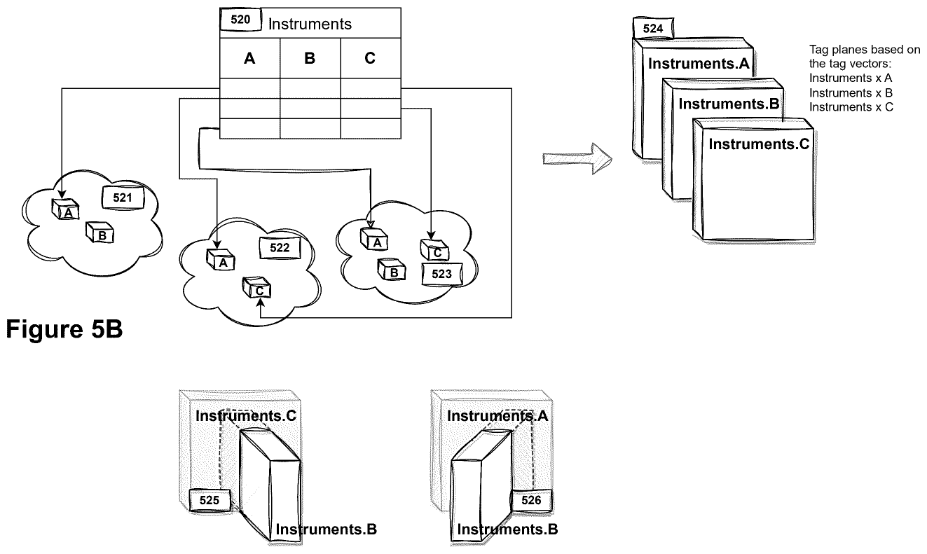

Referring to FIG. 5A, shown is a method of storing indexing data relating to different tag definitions also referred to as multi-dimensional tagging or tag sets. Each tag grouping as generated by a set of tag categories, at 510 is mapped with tag values at 511. This translates at 512 to sets of associations such that matches are a match against both the tag category and the tag value, for example in a category of “musical instruments” the value is “piano.” In this context, a match would occur and a reference association would be created at 513, if the context in the data element was a reference to the instrument that is a piano. What may not match in this instance may be a reference to a piano concerto being a piece of music rather than an instrument. Further, a reference to a clarinet—an instrument that is not a piano—would not match. However, if the next set of tags refers to musical compositions, then when that category is created at 515, piano concerto would later match at a repeat pass through 512 with the different category. In this manner multiple sets of match lists (based on the categories) are created at 515, resulting in the illustrated example of tag sets A, B, and C.

In this manner, indexing in the form of tagging is given multiple dimensions. Further, these multiple dimensions are variable, for example changing over time. In the previous example from FIG. 5A, the categories “musical instruments” and “musical compositions” each have separate sets of tag lists that contain at least one tag list referencing “piano”; resulting in the tag vectors “musical instruments.piano” and “musical compositions.piano”

The methodology described in FIG. 5A, can be applied recursively, for greater and greater refinement, each time adding more and more dimensions to the tag vectors. For example, consider a collection of cities, which have musical schools for various instruments. As illustrated in inset 515, each refinement produces a different dimension of further refined tag lists and associations, e.g., cities.schools.instruments or generically A.B.C as illustrated.

The data ingestion processes that produce these multidimensional tag vectors need not have been sourced or applied from the same locations and data sets. They need only be involved in data preparation. Same data ingestion processes are useful for a multiplicity of analyses.

Here, for example two data ingestion processes each include the tag “piano” but define the tag differently (or identically as the case may be). The resulting index data is not compatible one system to another because the tag piano has potentially different meanings in each index. Thus, each index is assigned a plane, for example designated by a prefix, to identify one index from another. Practically speaking, an index for the tag “piano” within an orchestra and created for piano moving and maintenance might be quite different from the tag “piano” created for teaching and hiring. Thus, the first might be referred to as maintenance.piano and the second as teaching.piano. Planar distinctions between tags and indexes can extend to multiple dimensions within organisations such that teaching.piano includes different definitions for different orchestras using a similar indexing solution resulting in Chicago.teaching.piano, etc. Analogous to object-oriented programming, each tag can have more global definitions that are replaceable or re-definable within specific contexts. For example, a piano might fall within the definition of weapon in the context of cartoons but is unlikely to fall within the definition of weapon in martial arts.

Alternatively, as described in the first tag example in step 501, tag prefixes come from a single table pertaining to the subject matter, such as a financial table taking column headers as the prefix and tag values as the main entry in step 502. Alternatively, as in the case within the illustrated example, multiple tables referring to pianos, musical instruments, musical compositions, schools, and maintenance are used offering a greater depth of prefixing/context setting. Further alternatively, a global table of definitions is imported with definitions being replaceable within contexts; an unreplaced definition of a tag remains usable at all levels.

Referring to FIG. 5B section (i), shown is an alternative method of storing index data where each tag generating a separate plane comprises a set of tags. At 520 multiple sets of tags under a single category, in this example Instruments, are shown. Each of A, B, and C are differentiated classes of instruments each with their own list of associated data elements. For example, A is pianos, B is oboes, and C is guitars. Each of these tag index lists capture matching references to data elements even in separate and non-contiguous data sets as represented by 521, 522, and 523. The tag vectors developed by these collective tag reference lists, instruments.pianos, instruments.oboes, and instruments.guitars, represent virtual data reference planes, instruments.A, instruments.B, and instruments.C generically as shown at 524 and called index planes.

Referring to FIG. 5B section (ii), illustrated here are the insights that are extractable from the tag indexing data and index planes. Shown at 525 and 526, the planar intersections of these index planes where the match is a set of tags, the associations with which can have meaningful interpretations. One example is where all associated data elements matched all of the source tags in both index planes set elements creating a set of planes where all associated data elements match all of the tag elements in the set as per FIG. 5A. By interpolating the intersection plane, the analyst is drawn to a new working data set, e.g., stringed instruments=intersection of instruments.pianos and instruments.guitars. Alternatively, where none of the planes intersect, often this fact is also of value for the analyst. By following these references, the analyst gets a sample insight of prospective customers who need their instruments tuned. In this manner, the virtual index planar interactions impact and offer actionable insights in the real world.

Separation of tags and their related indices into planes and organisations is highly advantageous, for example when overlayed with permissions, data privacy and security concerns.

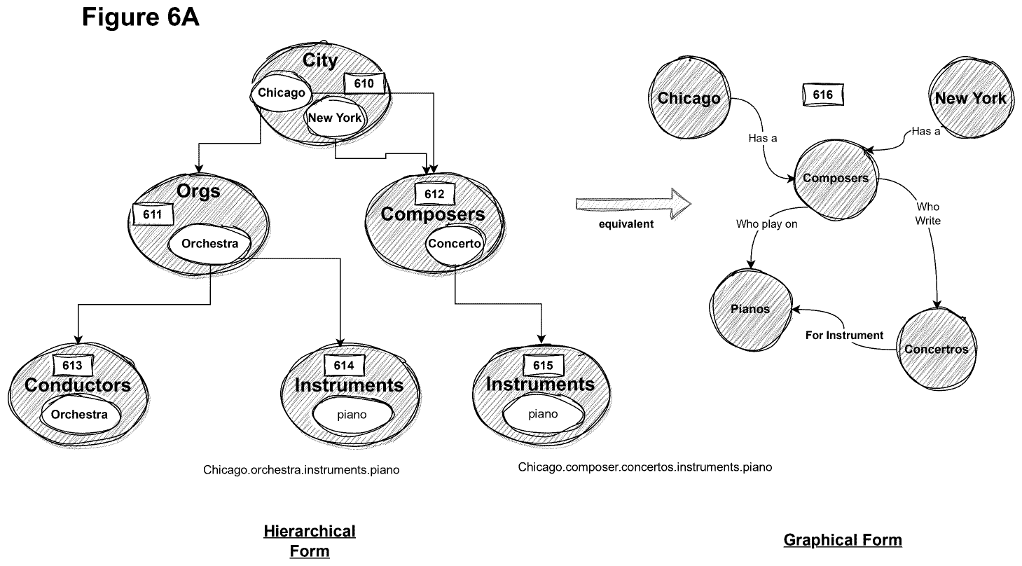

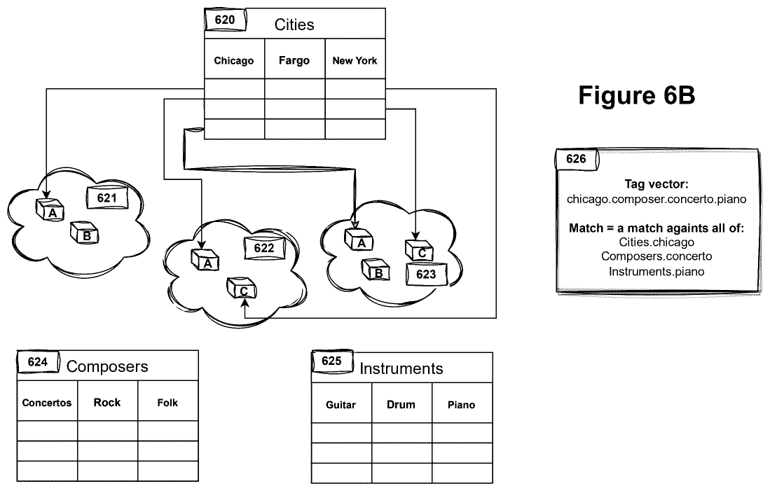

Though tags are described herein as indicators with definitions, in all embodiments, the definitions need not be flat in and of themselves. Shown in FIG. 6A is an object-oriented tag architecture wherein tags are defined hierarchically allowing for one data segment to be identified with a tag hierarchy or structure instead of a single tag. Thus at 614, a piano is identified by the tag hierarchy Chicago.orchestra.instrument.piano instead of simply by piano. A piano concerto if composed by a musician with the Chicago symphony orchestra might be identified as at 615, Chicago.composer.concerto.piano. The term hierarchy is somewhat misleading since, as illustrated at 612, concerto.piano is likely the same for a composer in Chicago and for a composer in New York, so it is to be understood hierarchies need not be formed as trees and instead might be better described as structured, graphs, or as tag vectors, and as multi-classification tags or multi-tags, for short, such as shown at 616.

Referring to FIG. 6B, shown is a similar outcome by processing each tag independently and then grouping tags that index same data. For example, the piano concerto described above would be linked to the following tags: Cities.chicago from 620, Composers.concerto from 624, Instruments.piano from 625. Any order of those tags in a grouping would always retrieve the tag if searching within same data so long as it matched all three, as illustrated in 626. Thus, hierarchy seems unimportant, but in each paradigm of processing or searching, hierarchy matters so that a hierarchical tag structure has benefits for defining some aspects of some embodiments.

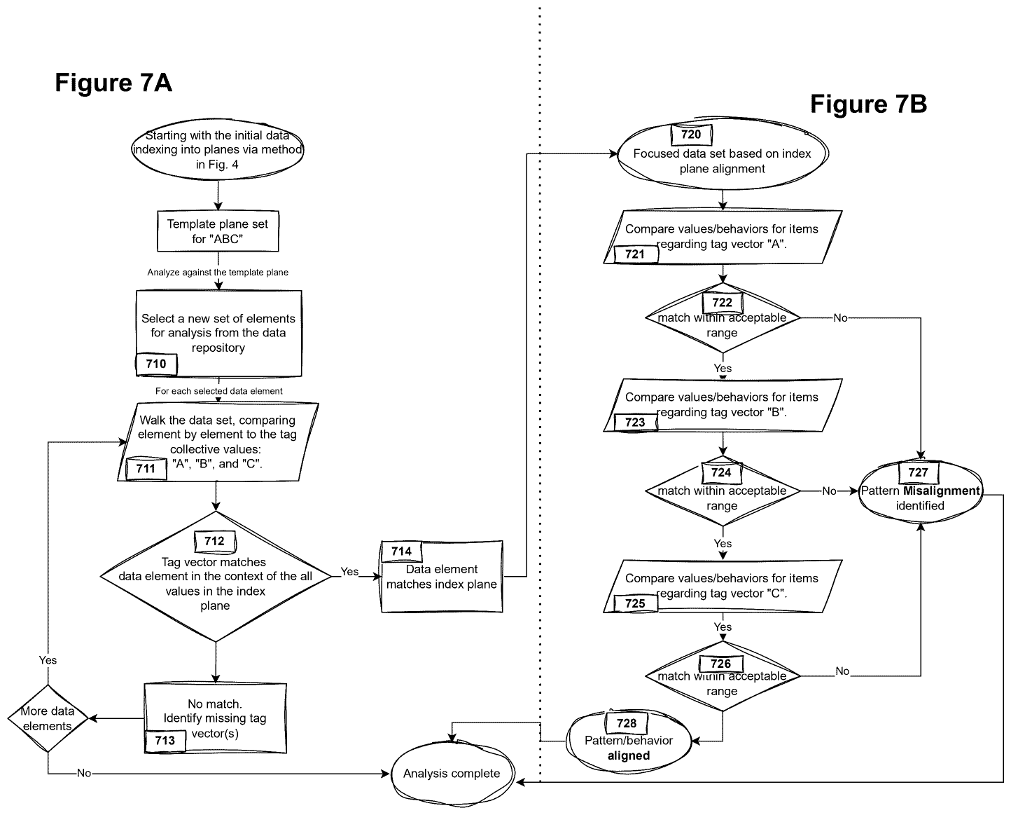

Referring to FIG. 7A, shown is a simple data retrieval and filtering process for a financial auditor of orchestras. The auditor is a volunteer who audits a large number of orchestras because she loves music. Here, for each orchestra, the auditor retrieves all financial records and matches them. The process she employs searches within datastores within a context of a single orchestral organisation for invoices, payments, approvals, etc. The data has been predigested according to a method such as that of FIGS. 4A-4D. The process then aligns invoices, approvals, and payments as best it can, running through the process outlined in steps 710 through 714. The resulting data set includes all unaligned values highlighted for detailed review at step 713 with all aligned segments presented for completeness at 714. With each aligned segment is linked the segments and data supporting the aligned segments. Similarly, with each unaligned segment is linked the data and supporting documentation relating to the non-aligned segments.

Thus, for example, for each payment an invoice, approval and bank withdrawal are shown in the aligned data. This verifies each payment as invoiced and paid. For some, however, the approval is missing and for others, the invoice. These are then reviewed in the audit process. The auditor can also, at their discretion or randomly, select aligned expenses to review same in the audit process.

Referring to FIG. 7B a secondary process, is shown executed by the auditor in steps 720 through 728. Here, the auditor processes data for several orchestras together to highlight sample expenses that may indicate issues. For example, one orchestra purchased a new Yamaha Grand Piano and another orchestra paid 5 times as much for the same model piano. One orchestra paid $10,000 for its director to go to a conference and another orchestra paid $37,000 for the same conference. Thus, the auditor can review expenses across their industry. Such a search and retrieval process aligns invoices and payments across orchestras for similar items and then allows the auditor to discern whether the expenses were warranted as in the alignment illustrated at step 728 or hide a significant issue as identified by the misalignment shown in step 727.

In some embodiments, with each issue found, the search and retrieval process improves as does the tagging and indexing system. For example, payments through certain third parties or out of petty cash may be highly indicative of fraud and so the process is adjusted to also extract and highlight those, focusing in on the intersection between the two tagged data sets.

Whereas petty cash balances kept in an excel spreadsheet may have originally been deemed insignificant, the updated tagging process tags and digests all petty cash related data and the processing and retrieval process extracts notable petty cash related issues.

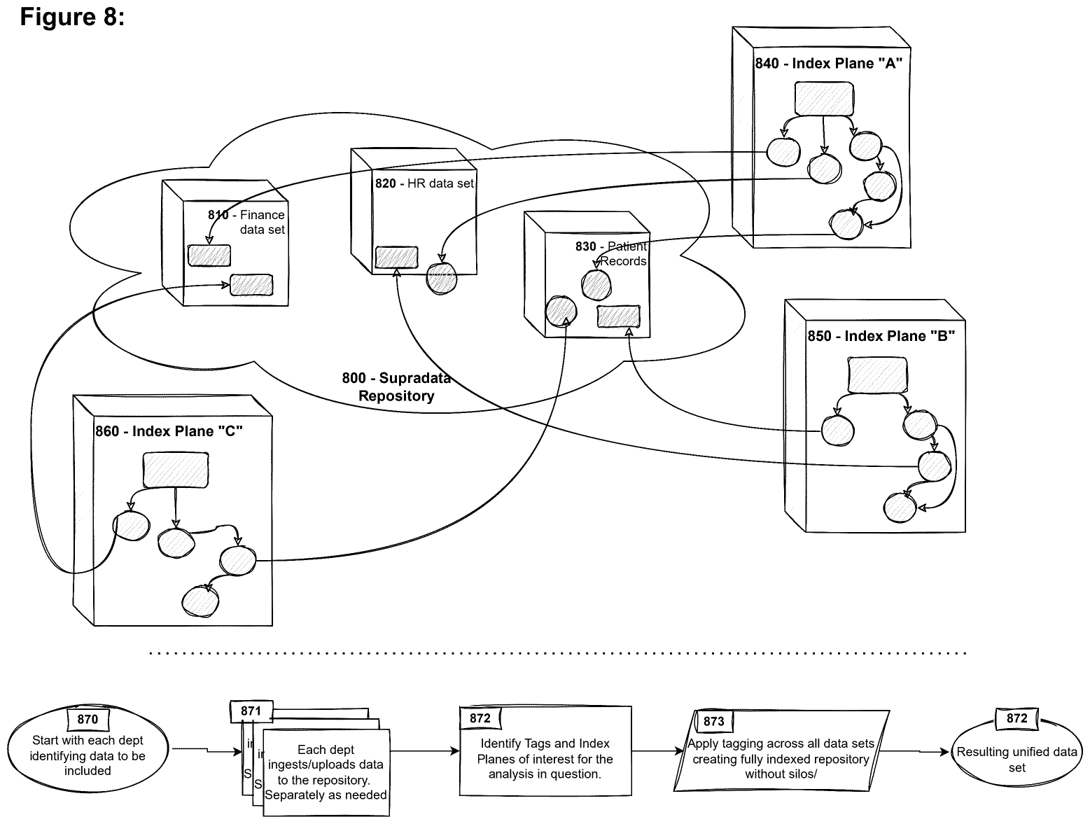

Turning to FIG. 8a, shown is a simplified illustration of a process for extracting hospital operations data. Hospital operations is a very complex process involving patients, patient privacy, doctors, doctor patient confidentiality, expense monitoring, performance monitoring, insurance monitoring, etc. Further, hospital data is stored in many different systems including planning, management, accounting, insurance, HR, medical records, patient records, etc. A context rich, structured tagging and data ingestion process is implemented across all data for the entire hospital; unifying the data across multiple silos. The individual data sources load separate data sets (810, 810, 820) into the supradata repository at 800. Alternatively, each department designs a data ingestion process relating to tags relating to reporting and data analysis for said department all still resulting in unified data in the shared repository of 800. With the data unified in the common repository 800, a multiplicity of tag vectors of interest are developed using the methodologies previously described above such as with reference to FIG. 4, comparing data across data sets resulting in index planes at 840, 850, and 860.

A traditional process as illustrated in a subsection of FIG. 8 can be described as any one of the individual departmental data sets. For example, a “Cleaning and Sanitary” or “Custodial” data set processes and retrieves data relating to tags relating to hospital cleaning. Data relating to each tag is previously ingested, stored and indexed such that the data processing and retrieval process of FIG. 8 is efficient. The returned information includes information about cleaning supplies, staffing, cleaning concerns and special cleaning requests. Cleaning supplies can be compared to cleaning concerns and cleaning requests. For example, if custodial staff had to disinfect each room twice as often, you should see a commensurate amount of disinfectant being used. Otherwise, a significant increase in disinfectant highlights an issue-either now or previous. The head of building operations uses the retrieved information to review performance and to explain performance related issues. However, this individual may not be authorized for information beyond their own department. Because custodial information requests are on the custodial plane of information, there is no access to financial, management, or patient data. Alternatively, there is limited or redacted access to some patient and/or financial data.

The development of the unified context illustrated in FIG. 8. Results in tags and index planes which span across data set, business, and ownership boundaries and use of the resulting tag structures enables a faster more efficient means of cross-correlation resulting in deeper insights with direct real-world impact. By unifying the data sets and cross-correlational tagging the relationships between otherwise apparently non-related data becomes directly searchable and identifiable. All of this can be achieved while adhering to the real-world regulatory constraints of data protection and data privacy.

Again referring to FIG. 8, a medical board of review of the hospital processes and retrieves medical performance reports for review. Again, the data is previously ingested at 810, 820, and 830 and a store including tags and associated data that is indexed is used in the processing and retrieval of the information at 800. This returned data from repository 800 might also include custodial data, for example someone slipped because of a custodial error or infection from hospital room 204 is unlikely because of custodial attention to detail in that room. That said the medical review board will also have access to confidential patient medical information, from 830. In fact, the custodial information available to the medical review board may be indexed on same or different tags than the tags used by the maintenance team. Optionally, the data used in processing custodial data by the medical board includes some same tags and some different tags.

Advantageously, tags defined for the medical review board are optionally used on multiple systems. Alternatively, tags are used differently on different systems, for example due to differences in data entry style or language.

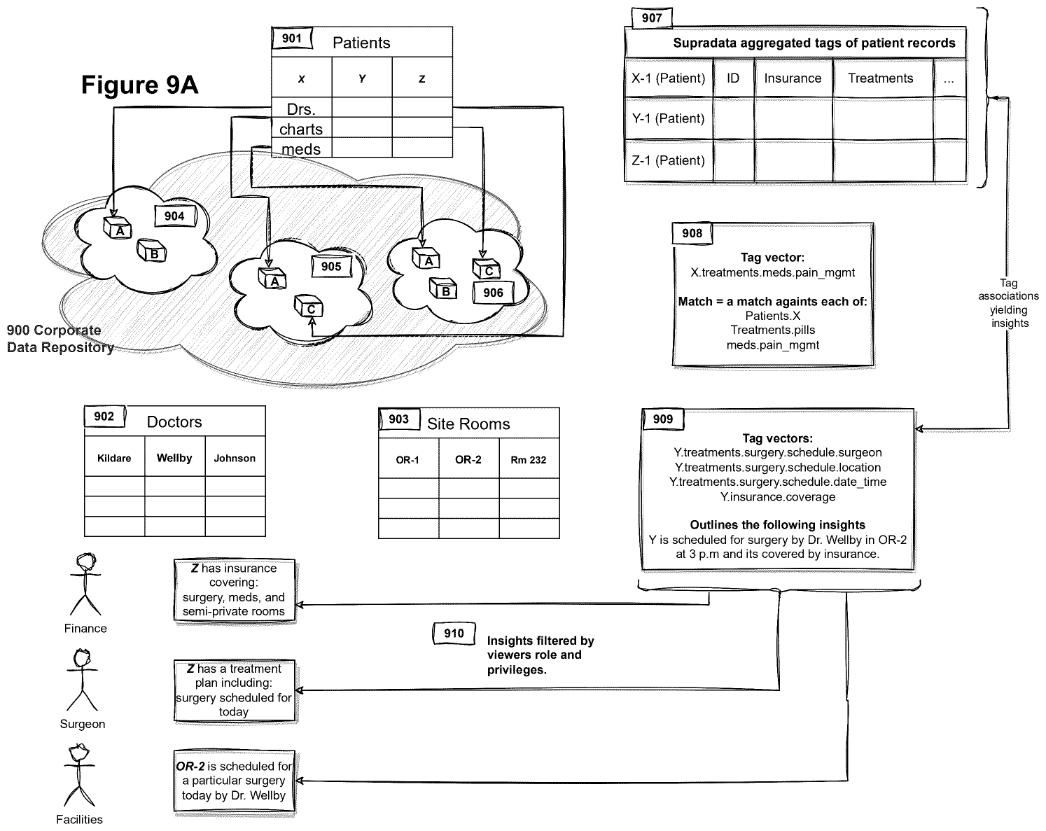

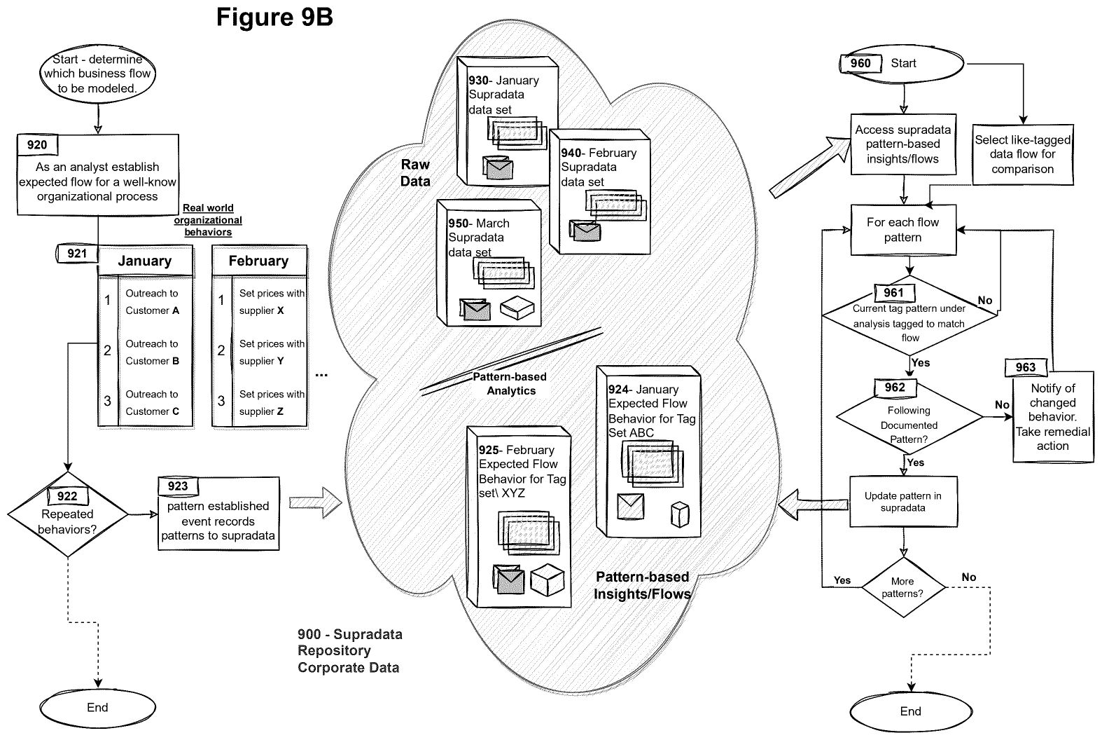

To highlight an exemplary embodiment, shown in FIG. 9A is a tag architecture linked to data sets that are sourced from separate segments of an organization, in the example, a health care facility. The combined data sets are uploaded and unified in the Corporate Data Repository at 900. The tag ‘patient’, shown at 901, is linked to doctor emails, medical charts, admission records, financial reporting, custodial interactions, nursing notes, medical notes, test results, photos, prescriptions, patient journal entries, schedules/calendars, etc. Each of these data sets is a distinct data set that is identifiable within the collective data lake at 901. For example, voice mails are stored in audio files, as in data set 904, and emails in email files and appointments in calendar files, illustrated by data sets 905 and 906, respectively, etc. That said, the tag for ‘patient’ X retrieves all relevant data relating to patient X within all hospital systems. This is achieved as follows: each data type has a generic process for analysis and specific markers for extraction. Thus, a same patient is identifiable by name, patient number, which may differ by visit, patient insurance number, etc. In each format, the data relating to the patient is compared during data ingestion—for a calendar file against an entry; for an email against a patient number, file number, test numbers, or an email address; for a test against an insurance number or patient number; etc. to determine if a given tag applies. The above process allows the system to have a tag for each and every individual patient. Similar tags for each and every doctor, at 902, illness, hospital rooms, at 903, nurse, etc. are supported with file analysis modules supporting element extraction across different media. The tag related context information retrieved when ingesting data is then stored in a separate data set, such as illustrated by 907, typically outside of the original datastore and at least outside the ingested data itself.

The information retrieved when processed using the tags is then stored in a data set. That said, the complete dataset may not be viewable by everyone due to privacy and data access restrictions. Thus, a requestor is only provided access to their permitted information. As illustrated at 909, multiple tag vectors or queries yield interesting information or insights. However, as shown at 910, the same queries yield differing views on the same data based on the requestor's role within the organization. For example, Ms. Smith in parking lot management can see only her own interactions—voicemails, emails, logs, etc.—with patient X while the medical review board can see all of patient X's medical interactions with staff, emails, voicemails, test results, etc.

The architecture of FIG. 9B shows multiple tags linked to multiple systems. Each tag is shown with a hierarchy of elements below the tag. For example, the tag “Invoice” has a subset “.related” for all invoice related material. Within “.related” are different groups including “.draft,” “.final,” “.letter_with,” “.quote,” etc. Within “.quote” is “.discussion” for all discussions relating to the quote and within “.discussion” are modules for voicemails, test messages, emails, pdfs, letters, files, etc. There is also within the “.discussion” hierarchy, a section for confidential internal discussion that is identical to “.discussion” but for internal confidential communications. Also, within the “Invoice.related” hierarchy are “.approval” under each of quote, invoice, and payment. For an invoice that is sent out, the “.approval” for payment is likely the accounting record of payment received, but it could also be internal approval to modify the amount received or waive the amount invoiced. Of course, discussions around those approvals are linked to the “Invoice” and find their way into the “.related” hierarchy.

This tag hierarchy which increases the context of a given data element is used to identify gaps in expected data sets. Given similar data elements, which share the same set of matching tag structures or flows, the analyst creates templates or tag flows, at 923. These tag flows indicate the expected set of tags that are consistent across the flow. This templated flow is retained in the corporate repository at 900. Templated flows are drawn from the repository for comparison to similarly tagged entities at 961. Where there are missing tags—tags from the flow which an individual data element does not have—the comparison at 961 identifies such; that is indicative of a hole, missing, or incomplete data, reported and logged at 963.

An auditor retrieves data by way of indexed tags for all invoices, for example in the accounts payable log. Each invoice is linked to a complete flow when one exists. From “request for quote” to “approval of payment”, the documentation is there and links to whoever requested/approved the amounts. This flow is the template for such invoices. When one or another document is missing, the system highlights this and the auditor checks to see if it matters. When it matters, the auditor looks at unassigned invoices and approvals. Highly advantageously, because of tagging of data elements within documents instead of tagging a document as a whole, it is possible for one approval to be retrieved for numerous quotes and numerous payments. It is also possible for one invoice to relate to multiple quotes and vis versa.

Thus, there is no unique relationship between tags and documents or between tags and categories. All documents that are within an “invoice,” for example, but not allocated to a subhierarchy, are just “.related” allowing the accountant, in this example, to look at the unallocated but related messages if an important document is missing. The accountant will likely know what they are looking for and therefore, given the reduced number of documents retrieved and predetermined knowledge of what is sought, the accountant can often make short work of the task of finding missing documents. Optionally, when found the accountant reassigns the document to its correct category, which generates a tag update request for review by staff and then, when approved, inclusion within a tagging processing system. In an embodiment, data ingestion is performed by a correlation processor and the new category assignment is added to training data to tune the correlation engine better to the intended task.

With advanced tuning of the correlation processor, it is often advantageous to digest the data differently for different tasks, allowing for each digestion to occupy an index plane of extracted tag data. When an organisation digests data differently for different tasks, this also allows for different data retrieval perspectives, for example the auditors might be best suited to answer some of the CFO's queries as opposed to the accounting department, since the accounting department tags and retrieves data differently. Similarly, though scheduling information is included in many quotes, the COO might be better to answer scheduling queries than the CFO as the data ingestion for the COO is likely more operations and scheduling than invoice and payment. When schedule affects budget, communicating with both departments may prove fastest and most effective.

Highly advantageously, when using tagging one can perform searches and queries and then access supporting documentation when it is still available. Thus, if an approval for an invoice is verified to be present, the auditor can still retrieve the approval and look at the actual message. This allows for verification of random entries to improve audit value, but it also allows for extensive access to data for process control, training, and risk mitigation.

For some data a system, user or group has limited data access, for example, external data from a government database may be confidential. In those situations, the digestion process can still execute as can analysis, but data retrieval is very limited, in a manner similar to that illustrated in FIG. 9A at 950. For example, an employer might be able to retrieve that an employee is disabled in the short-term, but not the nature of the disability. Tagging of each employee within the government database to provide specific answers to specific questions would simplify both the employee communication with the employer and the employer's need to verify certain details. Similarly, the employer may be able to retrieve that the employee has a drivers license. The set of responses available and to whom they are available would be governed by privacy and data security processes as well as by redaction software that would tag the data and extract from it redacted answers to questions for which a response is sought. In a corporate environment, the same might happen where an employee may be able to access a status with a purchaser-behind or current-without knowing actual numbers or what the definitions of behind and current are. Thus, for example, when a new hire at a law firm goes to enter a client for whom they will start working, the system can merely tell them “yes,” or “no,” and whom to see about it. That said, a partner with the same query might see actual numbers and an office manager or managing partner might see historical numbers, emails, payment schedules, etc.

By decoupling the associations tags and context from the actual physical source of the data segment, the file, document, email, etc., the efficiency of searching and managing the context of the data is enhanced without violating regulatory, governance, or privacy constraints. The need-to-know concept, highly understood in the field of security, can be efficiently and more performantly applied across a multiplicity of data sets with a multiplicity of data owners and roles.

As noted, tagging allows for indexing of disparate and different data into groups for common analysis or group related searching and analysis regardless of the ownership or actual location of the sources of the data elements. It also separates the data from the indexing allowing a system to perform analyses and to limit returned data. In some systems, analysis will be blocked from certain users. In some applications analysis will happen behind a security wall and results that are anonymized or redacted or very limited will still be returned. For example, a receptionist at the hospital might be able to retrieve the number of heart attacks that were admitted last month, but he may not have access to who the patients were. Conversely, a researcher might have access to much more information, but it may still be anonymized, so they do not know who the patient was. Of course, the doctor treating the patient must have full access to the patient records.

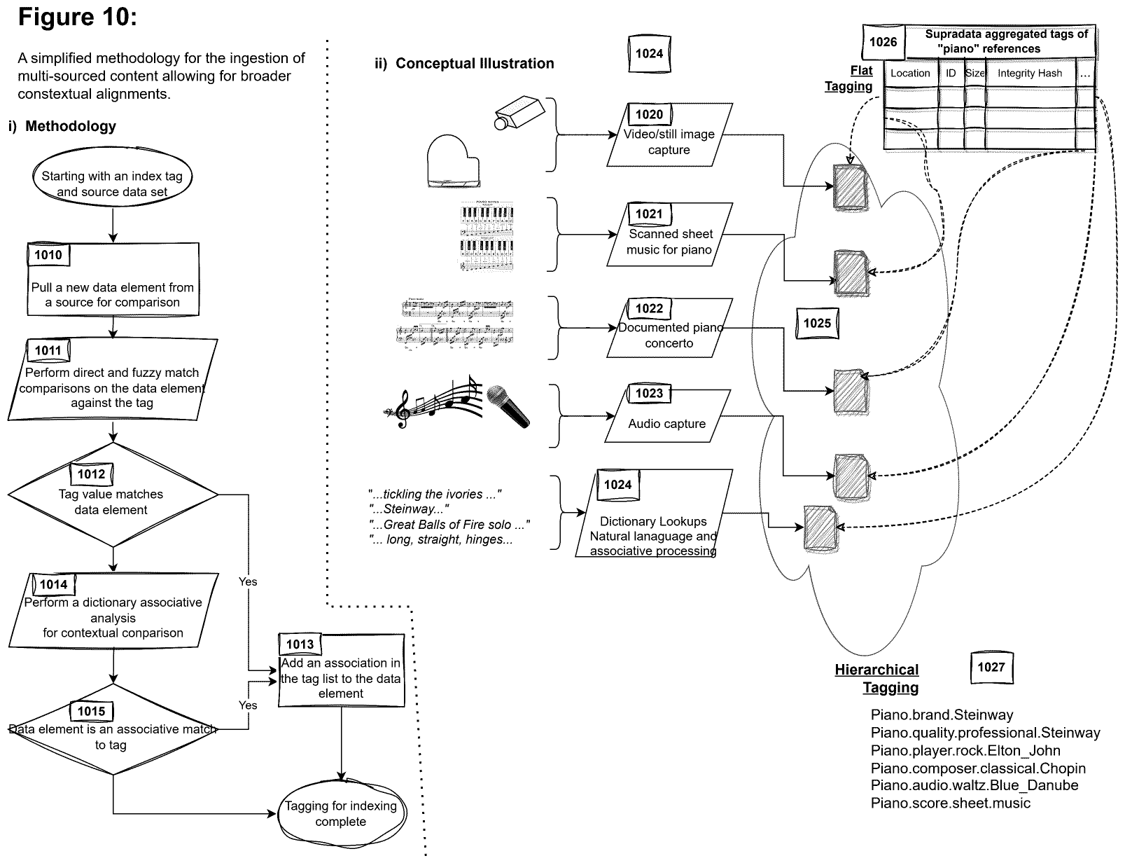

Referring to FIG. 10, shown in section (i) is a simplified diagram of a method of ingesting data. Here, for each element that is ingested, data relating to the element, its location, and a hash of the element to prevent undetected changes to the element in situ are all segments of contextual data retained. Illustrated is the broader concept of contextual indexing beyond a direct match. In section (ii), as illustrated for 1024, for the tag “Piano” there are a plurality of ingestion processes. Images are scanned with a correlation processor looking for an image of a piano at 1020, an image of piano sheet music at 1021, an audio processor assesses a recording of a piano at 1023 and an image of the word piano, potentially in multiple languages. A text processor looks for “piano” within text documents and word processing documents either searching text therein or using a document access module to access and search the text document. If a word processing document includes other elements, such as images, spreadsheets, or presentations, then those are each searched appropriately. As at 1024, a dictionary module for the tag “piano” also maps piano onto other concepts such as “tickling the ivories” in order to tag references that relate to pianos in common cultural references or in professional jargon. For example, “Steinway®” might be included in the dictionary as it is a very famous brand of high-end pianos. Also, famous piano players might be included. Now, in a flat “piano” tagging, each is simply tagged as related to “piano,” as shown at 1026. In a hierarchical model, each dictionary element can have a hierarchy associated with it allowing Steinway® to be “.brand” and “professional” while Elton John is “.pianist” and Chopin is “.composer,” as shown at 1027. This allows for a tag dictionary to be filled with information and groupings for searching for tags. The dictionary would also include other information such as images of a treble clef for the hierarchy “.sheet_music.” If cartoons are stored on the server, notes coming out of instruments might be identified by an image correlation processor as musical and associated with the hierarchy “.sheet_music” whether in “piano” or elsewhere.

Of course, in business applications, tags and hierarchies are set out for business purposes and will be enhanced through suggestions or direct input by users of a system. In other applications, tags are useful for generic tagging and organising of datastores for use in analysing and extracting data for other purposes, whether it is scientific study, artistic evaluation, information retrieval, or cataloguing. Of course, many other applications exist for properly indexed data.

Though the dictionary described above includes hierarchical identifiers, these hierarchical identifiers are also useful in a flat architecture. The intersection of the tags “piano” and “sheet_music” should be approximately the same as “piano.sheet_music” but allows for sheet music of any instrument to be grouped together with intersections taken to isolate one instrument. Because each tag is indexable, intersections between groups are efficient and the hierarchy becomes unnecessary. That said, in many business applications, sheet music will accidently be defined differently by different departments resulting in multiple incompatible planes of tags and related ingested data. The hierarchical approach allows each department to control its tags and hierarchies, with the organisation able to later consolidate hierarchies into groups of their own when possible. Conversely, when a datastore is tagged for general knowledge retrieval, it is often better to use a flat architecture except where context is important. For example, a clothing belt, a conveyor belt, a fan belt, and a seat belt are technically belts but context is highly beneficial as they are each typically retrieved in isolation one from another. Similarly, some terms have particular definitions or uses in specific fields and are often best tagged within their fields-within a hierarchy. Of course, even with belts, if they are all tagged as belts, the intersection with their field would likely approximately isolate the correct belt type, that said, identifying belts in images would likely require four separate belt identifiers, correlation engines, and as such might be best suited to an hierarchical implementation.

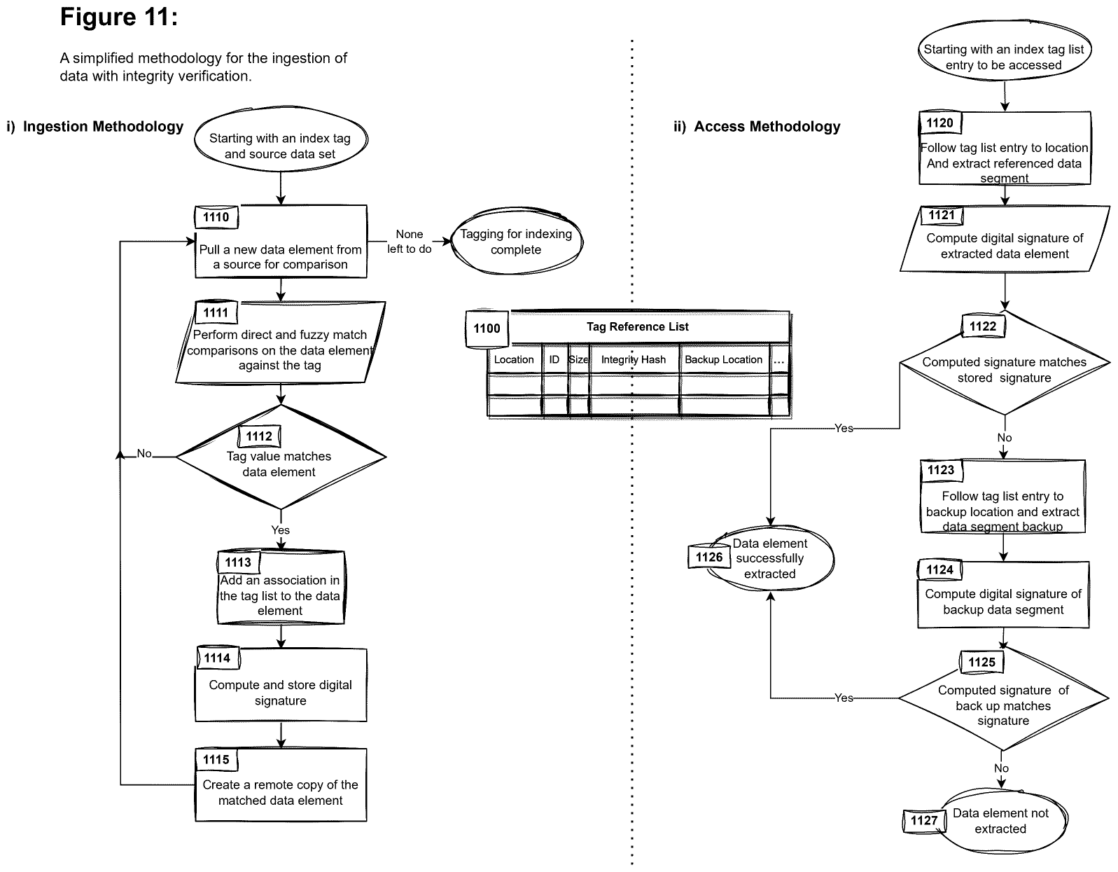

Referring to FIG. 11, shown is a simplified diagram of a method of ingesting data. Here, for each element that is ingested, data relating to the element, its location, and a location of a digitally signed copy of the element to prevent undetected changes to the element in situ are preserved in a reference record at 1100. In some applications, data is likely to be modified or deleted. In those applications it is often useful to preserve the original data or at the very least learnings from its context. Here, the original data is signed, at 1114, such that modified data cannot pass for the original data. The signature is optionally a hash of the data allowing for detection of changes or deletions, but not for correction or document retrieval. In such cases, a record, for example, is retrieved, via the methodology outlined at 1120, associated with a tag, the record is compared against the digital signature—the record is digitally hashed and the hash is verified against the digitally signed hash, as at 1121 and 1122. When the digitally signed hash is different than expected, the record is known to be different.

The implication of an altered data element offers several insights. Because the original tag was valid, a change in the data element is noted. Also, based on the context, even where the original data has been altered or deleted there is a preserved insight in that the original data element at the indicated location was associated with the tag in the past. When combined with several such tags (a tag vector or plane) conclusions about the original data element are deduced from the context where it was a member of the index plane(s) in question. One additional insight is the tag reference may no longer be valid.

In addition to the knowledge about the data element which transcends even its own existence, the altered or deleted element may be recoverable. An alternative path to recover the original is expected, as at 1123, if a backup exists, the backup is accessed to see if the backed-up record when hashed matches the expected hash result. Thus, only data that is verified is relied upon as being the ingested data and presented at 1126.

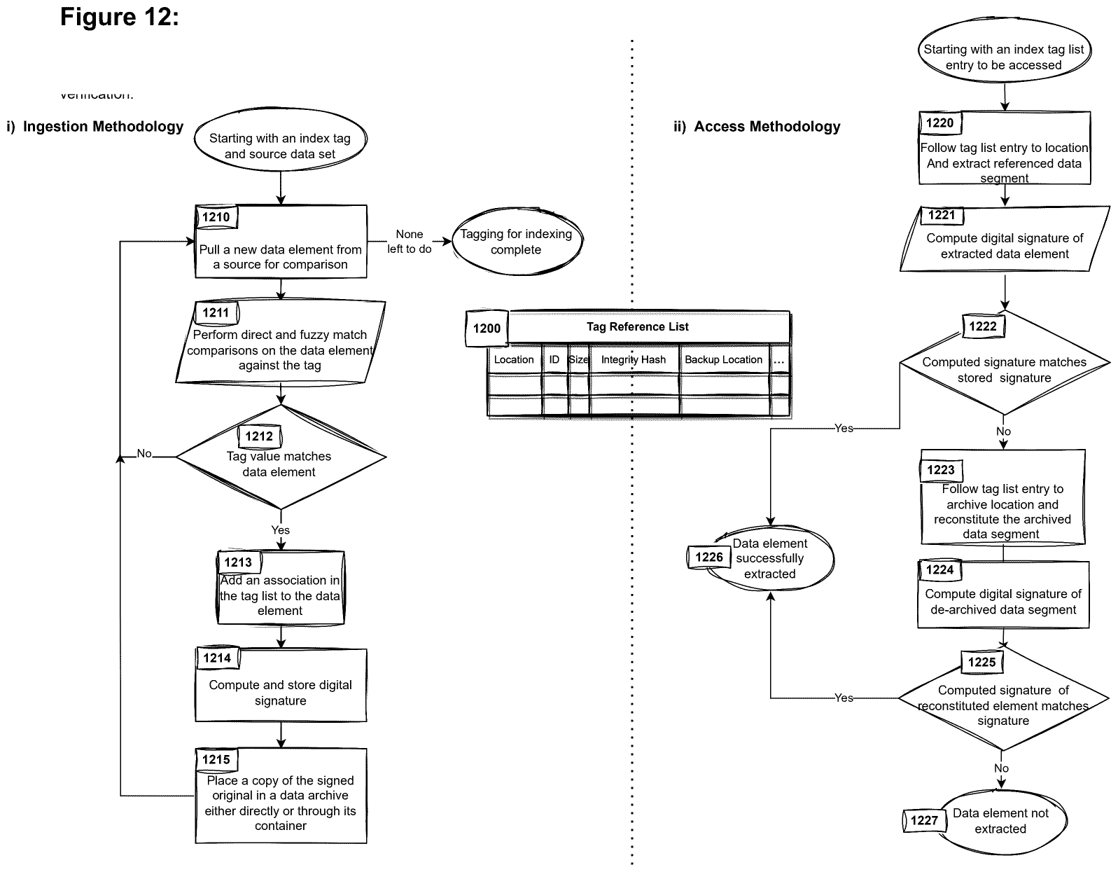

Referring to FIG. 12, shown is a simplified diagram of a method of ingesting data. Here, for each element that is ingested, a system stored data relating to the element, its location, and a digitally signed copy of the element to prevent undetected changes to the element in situ. Also, the record, file, or document in which the element is found is also stored within a data archive, for example using a standard data archiving tool, as noted at 1215. With many data archiving tools, data is stored once and then changes are stored thereafter to save on data storage requirements. So long as original files, records, etc. can be reconstructed from the archive, as at 1223, the reconstructed data is verifiable by hashing it and then comparing the hash against the digitally signed hash associated with the data element. When they match, at 1225, the original document is retrievable from the archive based on the digested data tags that are indexed for enhancing data searching and analysis.

In another embodiment, the data segment is a significant and traceable information fragment embedded within a file. For example, such a data element might be the document identifying unique number such as an invoice number, a purchase order number, or a serial number. In such cases, these data elements may be tagged with an indicator of the type of information/data which they represent, e.g., tagged “is an invoice number”. Similar to when the data element comprises a file, a data element which represents a segment of a file can also be digitally signed for data integrity purposes. Two methods are described as exemplar solutions. In the first method, where the data element is large enough for it to be meaningful, e.g., a section, chapter, paragraph, or clause of the document, the data segment string can be extracted and hashed independently from the enclosing file. In the second method, the information element is too small in size, being represented perhaps as short string of characters, e.g., invoice number “1234”, to digitally hash the data element. In such cases, the actual value of the string or its numerical representation can actually be used and maintained as the data integrity safeguard and maintained within the supradata.

In another embodiment, data is ingested locally to a system such that data ingestion and tagging is performed locally with the dataset of extracted tagged elements stored locally. For such a system to function, external users must know the tag definitions or trust the local data ingestion process sufficiently. In an embodiment, all systems rely on identical tags and identical tagged element definitions. Such a system allows users to analyse and retrieve answers across firewall, device, or cloud location boundaries without access to underlying data or even access to datum that are confidential or private. For example, a municipality might allow the public to access the number of traffic tickets issued each day, the number of traffic tickets issues in each section of the city each month, the number of arrests per week, etc. through a simple query portal, wherein each arrest is tagged as an arrest allowing police to effectively search and analyze arrest records and arrest details but also allowing the public to access limited anonymized information without exposing personal information or information involving an active investigation.

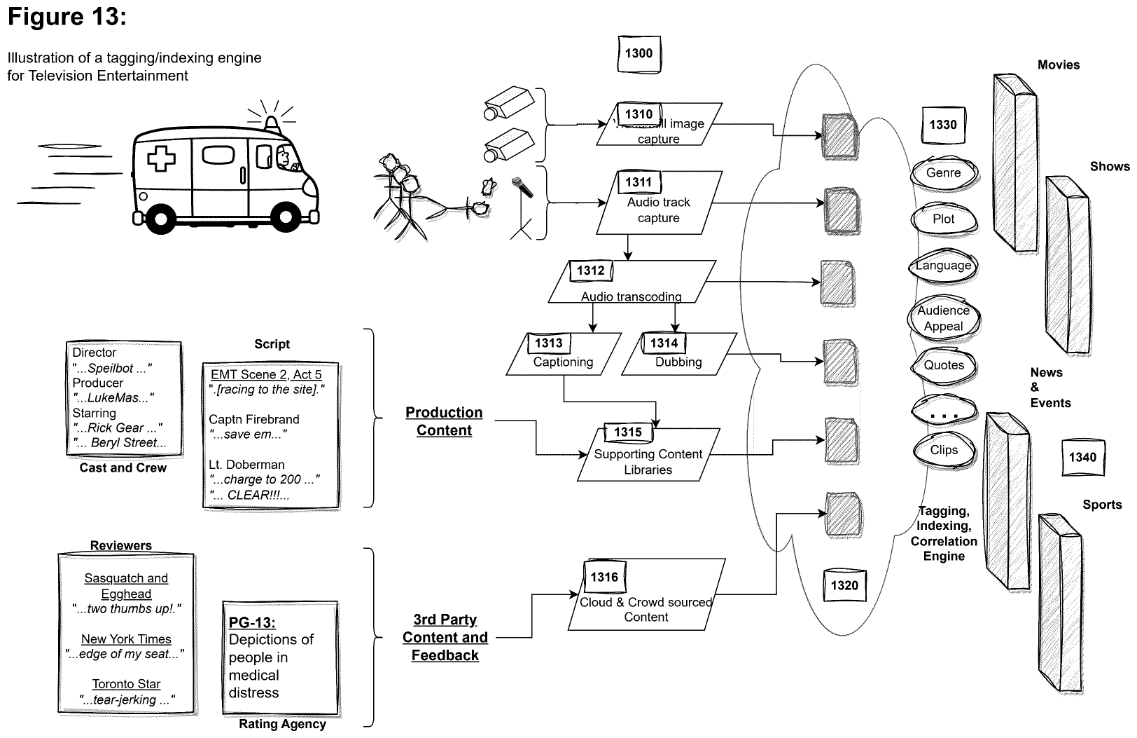

Referring to FIG. 13, shown is, a complex data analysis and retrieval engine for use in a television entertainment company. Television episodes are ingested relying on audio tags, video tags, caption tags, language tags, credit tags, etc, as illustrated at 1330. Thus, for each show, video data is digested to extract a script, such as at 1315 that is ingested relative to script related tags, tags are created for cast and crew at 1315, tags are also created for television show elements, such as “laugh_track,” “kiss,” “candlelit_dinner,” “gun,” and so forth. Television shows are then analysable based on tagged elements to extract shows such as at 1340 and determine likelihood of success based on known tags. When analysis is incorrect, new tags are definable to try to focus the analysis on proper predictions, essentially training the system. Once the system predicts as expected, shows can be grouped by audience type, demographic, timeslot, etc. for maximum impact. For example, including music or lighting or silence in the tagging might highlight another indicator of success leading to improved prediction. Similarly, tagging more elements might surprisingly place a television show in a category where it has not been used or shown, providing new audiences or new opportunities for current and past productions.

Imagine if a television show that was only shown in Portuguese comes up as being a potential hit in the USA if dubbed in English. Dubbing is cheaper than recreating an entire show, so it may provide an inexpensive avenue. That said, dubbing every Portuguese production may prove non-profitable if only one Portuguese show is successful in the United States. Thus, tagging and analysis can prove valuable.

Similarly, once tagged and analysed, people could choose to search shows with cats and guns but no kissing. A strange intersection results, but improving retrieval options and analysis options through ingesting of data with tagging allows for strange results as well as predictable results. Another advantage however, is that television shows can be retrieved based on tagged content. The show with Courtney Cox, or that show with the character “Silver.” Though Silver was not technically a character, the show can be retrieved. This, however, is far more intuitive because with proper tag selection, analysis and retrieval of television shows and films and music is fast and effective due to the pre-ingestion and indexing of tags.

Though television shows are used as an example of how flexible data ingestion is, many of the applications for data ingestion relate to multimedia data such as text, images, emails, documents, letterhead, signatures, voicemail messages, online communications and messaging, etc. commonly used in today's business enterprises. Further, as data analysis processes improve, data ingestion can be repeated to improve tagging or to tune tagging to particular applications.

Though tagging is described as a pre-processing step, in many applications tagging is an ongoing and ever-learning process. It continues for new data as it is added to a datastore. Thus, each email is ingested as it arrives. In a heavily dynamic system, there are times when ingesting data in transit or while operating is advantageous. Such ingesting might tag spelling errors made separately from spelling errors that were in a final document. In application to video, such an ingestion process might ingest video clips during the various stages of postproduction. Likely, it is the application and business value of data ingestion that will guide its use.

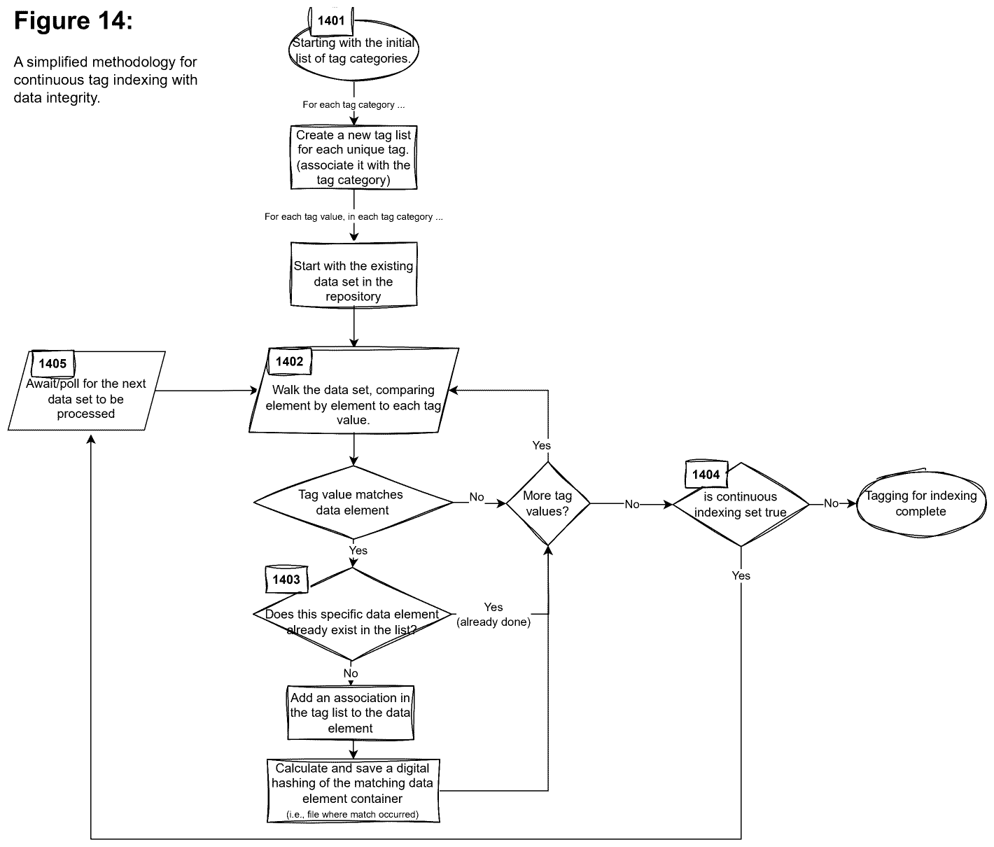

Referring to FIG. 14, shown is a simplified method for continuous tagging and indexing of existing and expanding data sets. In many real-world applications, not all data is known up-front at the beginning of an analysis. In the preceding example of video clips, such as generated during a movie production, new clips are added to the data set on a regular, perhaps daily, basis. It would be meaningful and efficient for the structured tagging and indexing which came into being early-on in the analysis of the data to continue throughout production. Through this methodology, the existing tag set can be applied to new data as it arrives or on a periodic or recurring basis, from 1402 through 1405. Where the data has already been tagged, no new tagging is introduced, as illustrated by 1403. Only when the new data matches against the tag set is it identified. In this manner, the data, both old and new, is reflected in the indexing and all remains searchable.

In another embodiment of the methodology, it is recognized that not only the data set changes over time, but so too can the set of meaningful and useful tags. In such situations, it is advantageous and necessary to ensure completeness by applying the tagging operation with the new tags over the historical data as well as any data which is added moving forward. In this manner, the entire tagging and indexing capability spans the entire data set.

Without limitation, real-world scenarios often include instances wherein both the data set and the tag set are updated and changed in an ongoing basis. Such solutions have checkpoints where the full data set that existed at the moment of the check point would be indexed and tagged with the full tag set that existed at that moment. These checkpoints themselves would over time form an interesting and useful timeline representation of the changing datasets and tags.

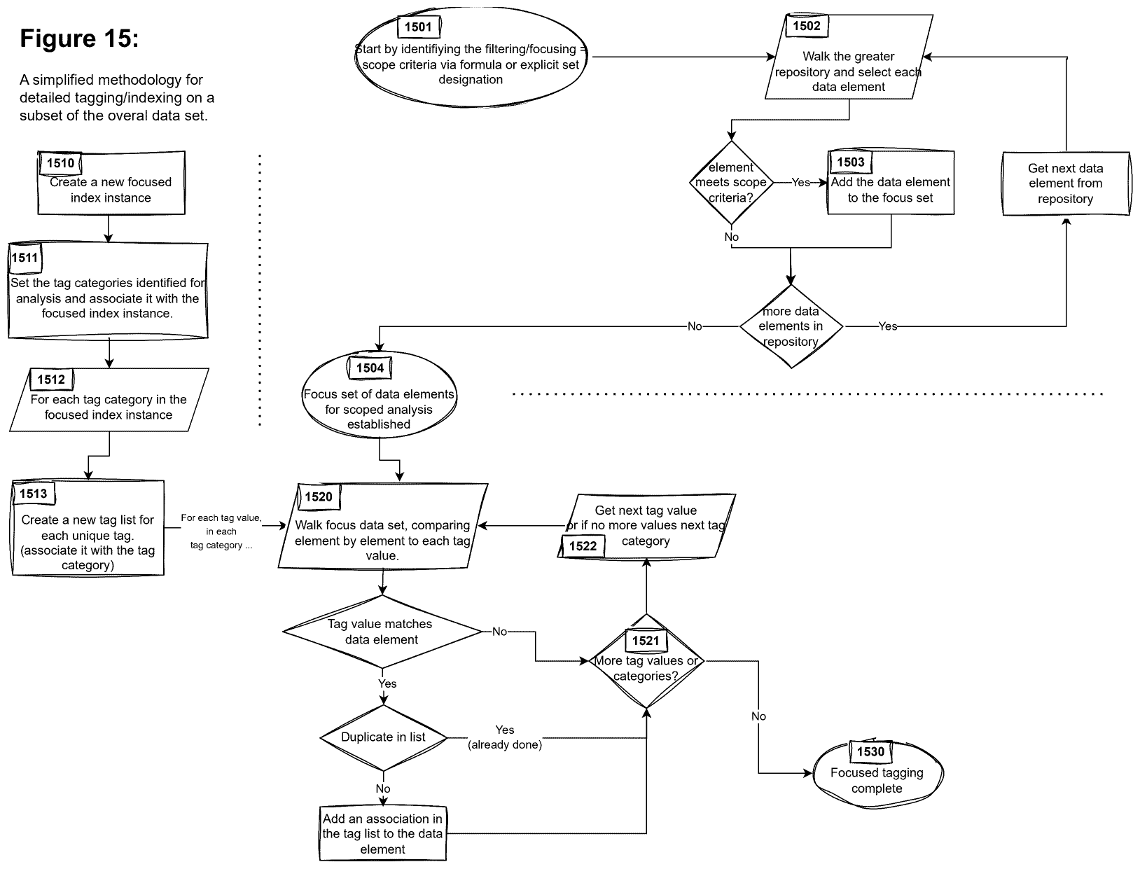

Referring to FIG. 15, shown is a simplified method for applying tagging and indexing to an identified subset of a much larger data set. During an analysis, it may be enlightening and lead to much more valuable insights for the analyst to examine the data more closely, applying more extensive and detailed tags to gain specific knowledge from the data set. Consider the piano example previously described, the analyst may wish to go into greater detail, e.g., identifying all pianos which were manufactured between 1800 and 1950, by firms operating in the New England region of North America, who used only imported wood materials in their construction. Examining the entire data set of all pianos to this level of detail may prove prohibitive in time, effort, or cost. The analyst can make the problem tractable again by restricting the source data set to a more manageable size, for example limiting this segment of the analysis only to pianos which were sold in the states of New York and Vermont. Therefore, it is advantageous to apply these detailed examinations to a focused subset of the much larger data repository, as developed by the methodology between 1501 and 1504. By applying the tagging and indexing operations with these more detailed and intrusive tags to the restricted subset the focused result is achieved, at 1530. Where this capability applies, it is also necessary to be able to denote when a tagging and indexing operation is scoped to something somewhat less than the complete dataset, as depicted in the new focused index instance established at 1510. This element of the methodology prevents confusion when analysis continues to ensure all analysts are aware, when the indexing and tagging does not extend to everything in the repository.

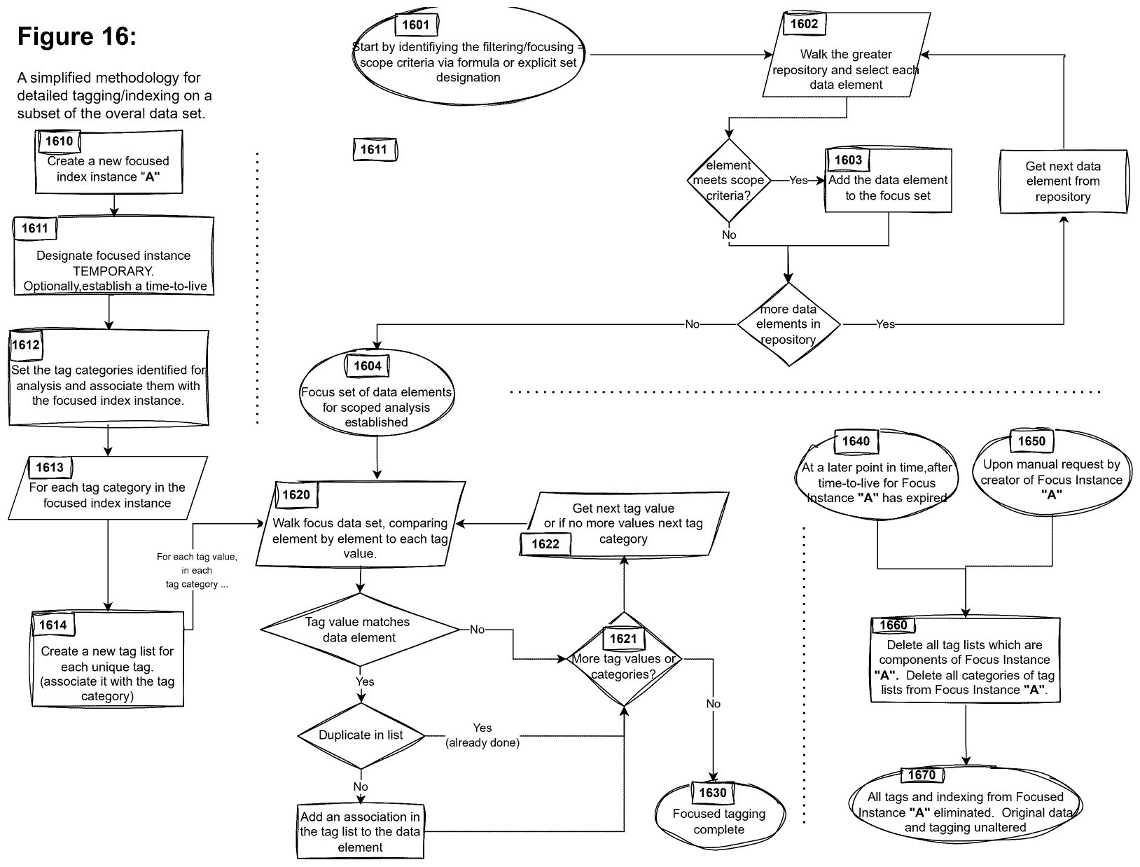

Referring to FIG. 16, which illustrates an alternative system and methodology, which allows for a tagging and indexing operation that does not span across the entire data repository. In this alternative, rather than having a set of tags which are only matched and indexed across a selected portion of the source data, but which remain in place when the analysis continues on, the set of tags and corresponding indexing are temporary; having either a designated life span (time-to-live) or being manually managed. They get removed when they no longer are of use. These temporary tags can apply either to the whole data set or as in FIG. 15 to a subset. But no confusion is introduced because they go away when this portion of the analysis no longer requires them.

All of the preceding analytical operations for tagging and indexing have been illustrated predominantly against documents or text-based content. However, the methodologies are directly applicable to other sources of information within a data repository. Because email messages are used in a lot of corporate communication, it is possible to analyse email messages in many contexts to extract significant information for use in evaluation, planning, verifying, communicating, training, improving processes, etc. It is also useful in email message management processes since email messages need not be preserved so long as the essential contextual information is within a supradata dataset. For example, once I know that for the last 5 years a customer was contacted between January 7^{th} and 9^{th}, I do not need the 5 emails reaching out and instead can store one exemplary proposed email and the supradata relating to the messages and their communication thread mappings. This allows for incorporation of email retention policies while maintaining information for future execution.

Without limitation, alternative forms of corporate communications are also prevalent in this era of social media and digital transformation. In the examples outlined, corporate communications focus on email. The supradata principles and capabilities are equally applicable to other forms of electronic communication including, but not limited to, SMS (simple messaging system aka texting), secure or private messaging systems such as offered by Slack® or Microsoft Teams® chat, even transcribed voicemails or live conversations over traditional phone lines, IP data lines or video conferencing applications and services. In each of these instances, organizational resources are being used for internal or external communications. With appropriate controls for governance and privacy, the organization is well within their moral bounds and legal rights to monitor these communications and glean insights from within. By applying supradata to the unstructured data, transcripts, listings, records, etc., offered by these alternative sources of corporate communications, no information gets lost in the shuffle. Supradata offers a cross-domain, cross-sources means of unifying and managing this source data and the information it contains to the benefit of the organization.

For example, consider a phone call between a buyer and a supplier. The buyer indicates a desire to buy a quantity of product, but the supplier is unsure if they can deliver from existing inventory. The supplier indicates they will get back to the buyer once they have had a chance to check their inventory. Both buyer and supplier in this instance are on the road so email is not a convenient communications medium. Upon checking the inventory, the supplier replies via SMS text the amount of inventory they can deliver by the buyer's target date. The buyer replies with their agreement on the deal. Eventually, when they get back to their respective offices, the buyer and supplier both update their financial and ordering systems (with or without errors in the updates). It would be advantageous, to have all communications associated with a tag relating to the deal allowing for retrieval of all correspondence relating to a single deal including correspondence relating to both that deal and others and linked to initial raw communications across the media, phone, text, letters, internal Slack®, and email Then further analysis could order or retrieve the actual communications by time, topic, and participants, to verify or audit the deal. The consistent context tagging available across these multiple mediums of communications offers considerably greater insight than traditional indexing or metadata, e.g., the time and date stamp on the recording of the original conversation. Further, ingestion of the communications to tag the data also allows for analysis of tagging within multiple domains by different processes associated with each tag. For example, ingested information is analysed for consistency providing each of the parties to the deal information about inconsistencies, “Tim just said our million-dollar deal, but the agreed upon price is 1.3 million dollars.” Thus, potentially avoiding human error in data entry. For example, when entering data into the ordering system, a bubble might appear stating that the order quantity extracted from text messages was different from that entered; this allows the buyer and supplier to check their respective communications for correct values, when indicated.

Further without limitation, it can be noted that all of the forms of tagging and complex indexing constructs above build relationships and associations between data elements. As demonstrated above, these relational mappings and the context they reflect carry insights into the information found in the data repositories under consideration. It should also be noted that these relationships and insights, collectively the learnings, from the context may be retained and continue to offer insight and value to the analyst, even after the original source data is gone. Put simply, the manner in which data element “A” is related to element “B” leading to insight “C” is persisted in supradata long after A and B may have been removed from the repository. This not only provides ongoing insight into the original A, B relationship it also defines a learnable pattern which can be applied with E similar to A and F similar to B leading to inferred insight G.

In some embodiments, the metadata is segmented metadata for each segment supporting a different function or system. In other embodiments the metadata for each system and function is different metadata collected and stored by different processes. In some embodiments, the metadata is linked to other metadata or within itself. In yet other embodiments, the metadata is linked to form a web of metadata that is traversable for analysis thereof.

In an embodiment, data is ingested from within a datastore. Ingesting the data is for determining supradata relating to the data. For example, supradata includes tags relating data elements to known classifiers. An example of a set of tags for purchasing is the following: {request, request for proposal, proposal, quote, final quote, invoice, payment}. An email and its associated attachments is ingested. In one of the attachments, the word “quote” is identified along with a description, a price, and terms and conditions. This attachment is tagged as a {quote}. The email is tagged as a cover letter for a quote. Alternatively, the email is not tagged. The tag {quote} is not purely based on finding the word “quote” within the document, but instead it is based on a plurality of features, the plurality of features occurring one in conjunction with another and not merely forming a single word or phrase. The plurality of features—for example see the features listed above—taken together form an indication of the classification {quote} to which the attachment, the data element, belongs and relating to which the attachment is tagged. Since, each of the plurality of features is identified within the same data element, a record is stored associated with the tag {quote}, the same data element—the attachment, and a location of the same data element within the datastore—the email to which it is attached and/or a location where the attachment is stored.

Using the above example, tagging is based on a group of features and not merely on a single word or single contiguous phrase.

In another example, instead of features being data within a document, a feature is the form of the document. For example, a form with a column of descriptors on the left and a column of prices on the right with a total at the bottom right and a date at the top right is tagged from a group of tag {quote, receipt, invoice}, given that the information within the form is compatible with one or more of those tags. Identifying, for example a government form allows for tagging based on form of a document instead of based on careful analysis of contents. Of course, tagging based on both form and contents is also supported.

In yet another example, a form is defined not by its appearance—as in a government standard form—but instead by its structure. An invoice, for example, has a date, a subtotal, taxes and total. It also has information about the seller and the purchaser. A receipt has the same fields but may be missing the purchaser information. A quote might include instructions to accept the quote—for example “sign to accept this quote.” When this is the case, documents can be identified and added to standard forms based on their “standard contents.” In some embodiments, the system displays a list and classification for each form identified to allow a user to confirm the classification. In this way, the system tags forms once it has learned a correct classification for those forms. Further, the system extrapolates to identify fields within the standard form for tagging. For example, tagging price, taxes, total, vendor, etc. are all tagged based on the known format of the identified form. The user optionally validates the automatic tagging on a first form to allow for correct automatic tagging of other identical or very similar forms.

When a correlation engine is used to determine tagging, the correlation engine receives a data element as input data and provides a tag as output data in response thereto. Sometimes, the correlation engine also indicates that another tag may have changed. For example, an invoice indicates that a prior quote was the final quote; a payment indicates that the invoice was accepted; etc. When a correlation indicates a change to a previous tag, either an additional tag is to be added or an existing tag is to be changed, the system identifies the tagged data element and adds or changes the tags accordingly. This allows later events to influence earlier tags. For audits and for information review, this form of back-correction of tagging is very useful. Final quotes are different than initial quotes and final contracts are different than contracts in discussion. Identifying which quote is the final quote once and tagging it as such I helpful when auditing or reviewing information.

Sometimes a tag or a back-correction indicates a problem. When this happens, a remediation process is provided for retagging other data elements in accordance with the remediation process. For example, a form thought to be an invoice is used as an invoice and as a quotation, though the quotation looks identical to an invoice. Once the final invoice is identified, it is easier to see that the previous versions of the invoice were merely quotations, quotes, and that retagging of them is proper. In other situations, the correlation engine identifies a real problem in tagging where tags are completely incorrect and need updating or replacing.

Alternatively, instead of processing data within a datastore, data is processed within at least one of a datastore and a datastream allowing data to be processed in transit or at rest.

Numerous other embodiments may be envisaged without departing from the scope of the invention.

What is claimed is:

1. A method comprising:
ingesting data from within a datastore comprising:
associating a plurality of features with a first tag;
correlating a data element within the datastore with the plurality of features, the plurality of features for occurring one in conjunction with another and not merely forming a single word or phrase, the plurality of features taken together forming an indication of at least one of a classification, purpose, or group to which the data element belongs;
upon detecting each of the plurality of features within a same data element, storing a record associated with the first tag, the same data element, and a location of the same data element within the datastore.

2. A method according to claim 1 comprising:
associating a plurality of second tags with the first tag, the second tags only occurring in some instances where the first tag has been associated with a data element, the second tags other than occurring when the first tag is other than associated with a data element;
wherein upon detecting each of the plurality of features within a same data element further comprises correlating the same data element within the data store to determine one or more of the second tags to associate therewith and associating the one or more second tags with the same data element by storing for each of the one or more of the second tags a record associated with said second tag, the same data element, and a location of the same data element within the datastore.

3. A method according to claim 2 wherein the first tag and the second tags are stored in a hierarchical data structure.

4. A method according to claim 2 wherein the first tag and the second tags are stored in an object-oriented data structure.

5. A method according to claim 1 comprising:
associating a plurality of features with a third tag;
correlating a second data element within the datastore with the plurality of features, the plurality of features for occurring one in conjunction with another and not forming a single word or phrase, the plurality of features taken together forming an indication of at least one of a classification, purpose, or group to which the second data element belongs; and
upon detecting each of the plurality of features within the second data element, storing a record associated with the third tag, the second data element, and a location of the same data element within the datastore.

6. A method according to claim 5 comprising:
when the first tag and the third tag are associated with the second data element, associating a fourth tag with the second data element.

7. A method according to claim 6 wherein the fourth tag is indicative of a status of the second data element.

8. A method according to claim 5 comprising:
when the first tag and the third tag are associated with the second data element, performing another tagging operation on the second data element, the another tagging operation associated with the first tag and with the third tag.

9. A method according to claim 1 wherein correlating is performed by a correlation engine, the correlation engine trained with a training data set comprising data elements and known tags for being associated with said known data elements.

10. A method according to claim 9 wherein correlating includes a step of verifying correlation results.

11. A method according to claim 1 wherein correlating is performed by a plurality of correlation engines in parallel, the correlation engines trained with training data sets comprising data elements and known tags for being associated with said known data elements.

12. A method according to claim 1 wherein correlating includes a step of verifying correlation results in dependence upon a correlation engine, the correlation engine trained with a training data set comprising data elements, output data provided by the correlation engine in response to said data elements and known correct output data for said data elements.

13. A method according to claim 1 comprising:
analysing at least the same data element in dependence upon at least the first tag.

14. A method comprising:
ingesting data from within a datastore comprising:
determining a plurality of data elements within a first document within a first data store;
determining a form of the first document;
based on the plurality of data elements and the form, determining a first tag for the first document; and
storing a record associated with the first tag and the first document.

15. A method according to claim 14 comprising:
determining a first status of the first document;
determining a second tag relating to the first status; and
storing a record associated with the second tag and the first document.

16. A method according to claim 15 comprising:
providing a first process having a plurality of documents associated therewith;
based on the first tag and the first document, determining a first process instance associated with the first process and with which the first document is associated;
determining other documents associated with the first process instance having a plurality of documents associated therewith and associated with each other; and
upon a change of status of another document associated with the first process instance, changing a status of the first document.

17. A method according to claim 15 comprising:
based on the first tag and the first document, determining other documents associated with the first document;
determining a sequence of the other documents and the first document for being matched against a known first process, the known first process including a documentary record of the known process comprising multiple documents;
storing an indication of the sequence of other documents and the first document, the sequence forming at least part of an instance of the known first process.

18. A method according to claim 17 wherein the known first process is an offer and acceptance process.

19. A method comprising:
providing a first tag relating to a first standard form;
mapping a plurality of data fields onto the first standard form;
identifying the data fields within an unstructured document;
tagging the unstructured document with the first tag; and
automatically learning a format, content and location of the unstructured document for future use in identifying and tagging documents similar to the unstructured document.

20. A method according to claim 19 wherein the first standard form is an invoice comprising a source, a destination, a date and an invoice amount.

21. A method according to claim 20 wherein automatically learning results in a process that identifies invoices in at least some different formats and document structures, each having data indicated in the first standard form.
